(19) United States
(12) Patent Application Publication
(10) Pub. No.: US 2022/0071230 A1
(43) Pub. Date: Mar. 10, 2022

(54) PLANT PROTEIN CONCENTRATES

(71) Applicant: BOTANECO INC., Calgary (CA)

(72) Inventors: Jason HARGREAVES, Calgary (CA); Kent SHAFER, Calgary (CA); Abhimanyu JAYAKUMAR, Calgary (CA)

(21) Appl. No.: 17/417,055

(22) PCT Filed: Dec. 20, 2019
(86) PCT No.: PCT/CA2019/051893

§ 371 Date: Jun. 21, 2021

Related U.S. Application Data
(60) Provisional application No. 62/783,308, filed on Dec. 21, 2018.

(51) Int. Cl. A23J 1/14; A23K 10/30; A23K 50/80; A23K 20/147; A23K 20/158; A23K 20/163; A23L 33/185; A23L 33/115; A23J 3/14

(52) U.S. Cl. CPC A23J 1/14; A23K 10/30; A23K 50/80; A23K 20/147; A23V 2002/00; A23K 20/163; A23L 33/185; A23L 33/115; A23J 3/14; A23K 20/158

(57) ABSTRACT

Disclosed are plant protein concentrates prepared from whole plant seeds or alternatively, from seed cakes or press cakes or seed meals or non-toasted solvent-extracted press-cakes, and the like. Plant seeds or seed cakes or press cakes or seed meals or non-toasted solvent-extracted press-cakes, and the like, are deconstructed and separated into heavy protein-rich fractions and light oil-rich fractions. The deconstruction processes avoid the use of organic solvents and temperatures above 60° C. The separated fractions are then selectively processed to produce selected plant protein concentrates comprising at least about 65% (w/w) plant protein, from about 4% (w/w) to about 10% (w/w) plant oil, from about 0.5% (w/w) to about 15% (w/w) carbohydrates, water, and ash. The plant protein concentrates are suitable for use as ingredients in nutritional formulations.

### CROSS-REFERENCE

This application claims the benefit of U.S. Provisional Patent Application No. 62/783,308 filed Dec. 21, 2018; the entire contents of Patent Application No. 62/783,308 are hereby incorporated by reference.

### FIELD OF THE DISCLOSURE

The present disclosure generally relates to protein preparations. More specifically, this disclosure pertains to protein concentrates recoverable from plant components.

### BACKGROUND

Plant materials may be an excellent source of edible oil and protein. Rapeseed (Brassica spp.), for example, is known to contain 40-48% oil and 18-25% protein. Furthermore, it is commonly known that rapeseed proteins include all of the nutritionally essential amino acids and have balanced amino acid compositions.

Plant materials with a high oil content (e.g. 35% or more) are typically processed with techniques that have evolved to optimize plant oil yield. In general, these processing techniques involve combinations of mechanical pressing and solvent extraction of selected plant material. After the oil is extracted, the remaining oilseed cake or meal may be used to extract plant proteins as a co-product. Protein extraction processes commonly involve heat treatment to remove extraction solvents from the oilseed cake or meal. However, due to the harsh processing conditions employed, the plant proteins recovered from oilseed cake or meal generally lose their native conformational state and form denatured or fractured structures. Preparations consisting primarily of denatured proteins are less suitable as a nutritional ingredient, since properties such as solubility, flavor, smell and color are generally all negatively impacted by the processing conditions. Rapeseed protein, for example, is therefore currently almost exclusively used as an animal feed.

Plant protein preparations recovered from oilseed cake or meal following oil extraction, may also contain undesirable non-protein constituents including glucosinolates, polyphenols, phytate, insoluble non-starch polysaccharides (NSPs), and the like. Glucosinolates when hydrolysed can cause adverse health effects in animals. Polyphenolic compounds impart bitter and astringent tastes to the human palate thereby making protein preparations containing these chemical compounds less suitable for nutritional purposes. When present in animal and aquaculture feeds, insoluble non-starch polysaccharides can interfere with feed utilisation and can have a negative impact on animal growth. Phytate can bind to dietary minerals and trace elements such as zinc, iron and calcium, thereby inhibiting the uptake of these minerals. Together, these undesirable non-protein compounds in plant materials are sometimes referred to in the art as anti-nutritional compounds. Anti-nutritional compounds are preferably absent in plant protein preparations intended for inclusion dietary formulations.

Thus, it is clear that while plant materials represent a valuable source of proteins, the quality of protein preparations obtained from these plant materials known to the art is suboptimal.

### SUMMARY

The embodiments of the present disclosure generally relate to protein preparations obtainable from plant materials.

One embodiment disclosed herein relates to plant protein concentrates comprising at least about 65% (w/w) plant protein, from about 4% (w/w) and to about 10% (w/w) plant oil, and from about 0.5% (w/w) and to about 15% (w/w) carbohydrates.

According to one aspect, the protein concentrates may comprise at least about 70% (w/w) plant protein.

According to another aspect, the protein concentrates may comprise at least about 75% (w/w) plant protein.

According to another aspect, the protein concentrates may comprise from at least about 65% (w/w) to about 85% (w/w) plant protein.

According to another aspect, the plant proteins within the plant protein concentrates may be substantially non-denatured.

According to another aspect, the protein concentrates may comprise proteins which are at least about 75% digestible.

According to another aspect, the protein concentrates may comprise proteins which are at least about 95% digestible.

According to another aspect, the protein concentrates may comprise proteins which are at least about 99% digestible.

Another embodiment of the present disclosure relates to protein concentrates comprising weight percentages of essential amino acids of at least about 30% by weight crude protein.

Another embodiment of the present disclosure relates to protein concentrates comprising weight percentages of essential amino acids of at least about 35% by weight crude protein.

Another embodiment of the present disclosure relates to protein concentrates comprising weight percentages of essential amino acids of at least about 40% by weight crude protein.

According to an aspect, the weight percentages of lysine in the protein concentrates may be at least about 3.0% by weight crude protein.

According to another aspect, the weight percentages of lysine in the protein concentrates may be at least about 5.0% by weight crude protein.

According to another aspect, the weight percentages of lysine in the protein concentrates may be at least about 7.0% by weight crude protein.

Another embodiment relates to protein concentrates disclosed herein having moisture contents from a range of about 4% (w/w) to about 10% (w/w).

Another embodiment relates to protein concentrates disclosed herein having ash contents from about 0.1% (w/w) to about 12% (w/w).

Another embodiment relates to protein concentrates disclosed herein, wherein the protein concentrates are be substantially free of at least one of anti-nutritional constituents selected from a group consisting of glucosinolates, polyphenols, tannins, sinapine, phytate, and stachyose.

According to one aspect, the protein concentrates disclosed herein may be substantially free of insoluble non-starch polysaccharides.

Another embodiment of the present disclosure relates to protein concentrates that are obtainable or obtained from whole plant seeds by a comminuting process.

According to one aspect, the protein concentrates may be obtainable or obtained from a Brassica plant.

According to another aspect, the protein concentrates may be obtained from whole plant seeds with a comminuting process that comprises wet milling whole plant seeds to produce a mixture comprising wet-milled plant seeds.

Another embodiment of the present disclosure relates to methods of making a plant protein concentrate, wherein the methods comprise:
(i) providing whole plant seeds;
(ii) comminuting the plant seeds in an aqueous solution to obtain a mixture comprising comminuted plant seed particles having mean particle sizes in a range of about 5 μm to about 200 μm;
(iii) separating the mixture into a solid phase and a liquid phase;
(iv) separating the liquid phase into a light liquid phase and a heavy liquid phase;
(v) separating the heavy liquid phase to recover therefrom a protein-containing heavy liquid phase and an oil-containing light liquid phase;
(vi) precipitating protein from the protein-containing heavy liquid phase thereby producing a solid first protein precipitate and a liquid protein solution.

According to one aspect, the present methods may additionally comprise a step (vii) of concentrating the solid first protein precipitate from step (vi) to produce a first protein concentrate.

According to another aspect, the present methods may additionally comprise a step (viii) of treating the liquid protein solution from step (iv) by ultrafiltration to obtain a retentate and a step (ix) of concentrating the retentate to produce a second protein concentrate.

According to another aspect, the present methods may additionally comprise a step (x) of blending a selected quantity of the retentate from step (viii) with a selected quantity of the first protein precipitate from step (vi) to produce a protein blend, and then concentrating the protein blend to produce a third protein concentrate.

According to another aspect, the present methods may additionally comprise a step (xi) of concentrating the retentate to produce a concentrated retentate, and a step (xii) of blending the concentrated retentate from step (xi) with the concentrated precipitate from step (vii) to produce a fourth protein concentrate.

Another embodiment of the present disclosure pertains to protein concentrates produced by the methods disclosed herein, wherein the protein concentrates may comprise at least about 65% (w/w) plant protein, from about 4% (w/w) to about 10% (w/w) plant oil, and from about 0.5% (w/w) to about 15% (w/w) carbohydrates.

According to an aspect, the present protein concentrates may have a moisture content of less than 10% (w/w).

Another embodiment of the present disclosure relates to nutritional compositions comprising a plant protein concentrate produced with the methods disclosed herein wherein the plant protein concentrate comprises at least about 65% (w/w) plant protein, from about 4% (w/w) to about 10% (w/w) plant oil, and from about 0.5% (w/w) to about 15% (w/w) carbohydrates.

According to one aspect, the nutritional formulation may be an animal feed.

According to another aspect, the nutritional animal feed formulation may be a juvenile animal feed formulation.

According to another aspect, the nutritional formulation may be a foodstuff for human consumption.

According to another aspect, the nutrient formulation may be a poultry feed formulation.

According to another aspect, the nutritional formulation may be an aquaculture feed.

According to another aspect, the aquaculture feed formulation may be substantially free of insoluble non-starch polysaccharides.

According to another aspect, the aquaculture feed formulation may be a fish feed.

According to another aspect, the aquaculture feed formulation may be a salmon fish feed.

Another embodiment of the present disclosure pertains to a nutritional aquaculture feed formulation comprising a digestible arginine content of at least about 93% to about 100%; a digestible histidine content of at least about 92% to about 100% digestible; a digestible isoleucine content from at least about 84% to at least about 93%; a digestible leucine content from at least about 83% to at least about 94%; a digestible lysine content from at least about 90% to at least about 96%; a digestible methionine content from at least about 94% to about 100%; a digestible phenylalanine content from at least about 85% to at least about 95%; a digestible threonine content from at least about 84% to at least about 97%; a digestible tryptophan content from at least about 95% to about 100%; and/or a digestible valine content from at least about 80% to at least about 95%.

Another embodiment of the present disclosure relates to method of preparing nutritional formulations, the method comprising:
(i) providing a plant protein concentrate produced by the methods disclosed herein, said plant protein concentrate comprising at least about 65% (w/w) plant protein, from about 4% (w/w) to about 10% (w/w) plant oil, and from about 0.5% (w/w) to about 15% (w/w) carbohydrates;
(ii) providing a formulary ingredient suitable for inclusion in a nutritional formulation; and
(iii) blending together the plant protein concentrate with the formulary ingredient to form a nutritional formulation comprising the plant protein concentrate disclosed herein.

### BRIEF DESCRIPTION OF THE DRAWINGS

These and other features of the disclosure will become more apparent in the following detailed description in which reference is made to the appended drawings, wherein:

FIG. 1 is a schematic block diagram illustrating an example process 10 according to an example of an embodiment of the present disclosure, for making plant protein concentrates;

FIG. 2 is a schematic block diagram illustrating an example of a subprocess of the process 10 illustrated in FIG. 1;

FIG. 3 is a schematic block diagram illustrating another example process 80 according to another example of an embodiment of the present disclosure, for making plant protein concentrates;

FIG. 4 is a schematic block diagram illustrating an example of a subprocess 83 of the process 80 illustrated in FIG. 3;

FIG. 5 is a schematic block diagram illustrating another example of a subprocess 84 of the process 80 illustrated in FIG. 3;

FIG. 6 is a schematic block diagram illustrating yet another example of a subprocess 85 of the process 80 illustrated in FIG. 3;

FIG. 7 is a schematic block diagram illustrating a further example of a subprocess 86 of the process 80 illustrated in FIG. 3; and

FIG. 8 is a FTIR spectrum of a canola protein concentrate according to an embodiment of the present disclosure, comprising a blended precipitate and concentrate produced by methods disclosed herein.

### DETAILED DESCRIPTION

As used herein and in the claims, the singular forms, such as “a”, “an” and “the” include the plural reference and vice versa unless the context clearly indicates otherwise. Throughout this specification, unless otherwise indicated, “comprise,” “comprises” and “comprising” are used inclusively rather than exclusively, so that a stated integer or group of integers may include one or more other non-stated integers or groups of integers. The term “or” is inclusive unless modified, for example, by “either”. The term “and/or” is intended to represent an inclusive or. That is “X and/or Y” is intended to mean X or Y or both, for example. As a further example, X, Y and/or Z is intended to mean X or Y or Z or any combination thereof.

When ranges are used herein for physical properties such as molecular weights, chemical properties, chemical formulae, and the like, all combinations and sub-combinations of ranges and specific embodiments therein are intended to be included. Other than in the operating examples or where otherwise indicated, all numbers expressing quantities of ingredients or reaction conditions used herein should be understood as modified in all instances by the term “about.” The term “about” when referring to a number or a numerical range means that the number or numerical range referred to is an approximation within experimental variability (or within statistical experimental error), and thus the number or numerical range may vary between 1% and 15% of the stated number or numerical range, as will be readily recognized by the context. Furthermore, any range of values described herein is intended to specifically include the limiting values of the range, and any intermediate value or sub-range within the given range, and all such intermediate values and sub-ranges are individually and specifically disclosed (e.g. a range of 1 to 5 includes 1, 5, and all values therebetween). Similarly, other terms of degree such as “substantially” and “approximately” as used herein mean a reasonable amount of deviation of the modified term such that the end result is not significantly changed. These terms of degree should be construed as including a deviation of the modified term if this deviation would not negate the meaning of the term it modifies.

Unless otherwise defined, scientific and technical terms used in connection with the formulations described herein shall have the meanings that are commonly understood by those of ordinary skill in the art. The terminology used herein is for the purpose of describing particular embodiments only and is not intended to limit the scope of the present disclosure, which is defined solely by the claims.

All publications, patents, and patent applications referred herein are herein incorporated by reference in their entirety to the same extent as if each individual publication, patent or patent application was specifically indicated to be incorporated by reference in its entirety.

The term “Brassica” as used herein, refers to a plant belonging to the biological genus Brassica and includes without limitation, the species Brassica napus, Brassica juncea, Brassica carinata, Brassica nigra and Brassica rapa, as well as Camelina species.

The term “essential amino acids” as used herein, refers to histidine, isoleucine, leucine, lysine, methionine, phenylalanine, threonine, tryptophan, and valine. It is noted that in at least some fish species including without limitation, salmon, arginine may additionally be considered an essential amino acid.

The term “comminuting” as used herein, refers to a process for deconstructing plant material into particles having sizes in a range from about 5 μm to about 200 μm and therebetween, wherein the process is exemplified by wet milling, grinding, homogenization, and the like.

The phrase “formulating the protein concentrate to form a nutritional product” as used herein, refers to mixing or blending a protein concentrate produced by the methods disclosed herein, at least one other ingredient suitable for inclusion in a nutritional product.

In overview, it has surprisingly been realized that plant protein concentrates containing high concentrations of protein moieties, and some oil and carbohydrates may be recovered from comminuted whole plant parts, wherein the protein moieties are substantially free of heat or solvent damage and thus are present in a non-denatured conformational state. The plant protein concentrates produced by the methods disclosed herein may contain substantial quantities of essential amino acids including lysine among others. The present plant protein concentrates may be substantially free of non-protein anti-nutritional compounds. Furthermore, the plant protein concentrates disclosed herein are surprisingly, substantially free of insoluble non-starch polysaccharides and retain desirable color, smell, and flavor profiles.

The plant protein concentrates of the present disclosure are useful for the preparation of nutritional formulations including for example, nutritional aquaculture formulations, nutritional animal feed formulations, nutritional poultry formulations, nutritional formulations suitable for human consumption, among others. The plant protein concentrates disclosed herein may be highly digestible (up to 99%), and since they may be prepared to be substantially free of anti-nutritional compounds, they do not negatively impact the health or development of the species consuming the nutritional formulations comprising the plant protein concentrates. Furthermore, the residual presence of plant oils in the present plant protein concentrates may be beneficial as energy sources in nutritional formulations. The presence of plant oils in the present plant protein concentrates may obviate the need for addition of extraneous oil into aquaculture and other nutritional feed formulations.

In what follows, selected embodiments of plant protein concentrates and processes for preparing plant protein concentrates are described with reference to the drawings.

Accordingly, one embodiment of the present disclosure pertains to a plant protein concentrate comprising at least about 65% (w/w) plant protein, from about 4% (w/w) to about 10% (w/w) plant oil, and between about 0.5% (w/w) to about 15% (w/w) carbohydrates.

The plant protein concentrates disclosed herein may be prepared from whole seeds of selected plant species. Suitable plant species for use with the methods disclosed herein for production of the plant protein concentrates disclosed herein belong to the Brassica family and include Brassica napus, Brassica juncea, Brassica carinata, Brassica nigra, Brassica rapa, Camelina spp. among others.

According to some embodiments, the plant protein concentrates may be prepared from processed plant materials such as for example, seed cakes, press cakes, seed meals, non-toasted solvent-extracted press-cakes, and the like.

Examples of embodiments of the present methods generally comprise the steps of deconstructing whole seeds of selected plants with a selected comminuting process to produce comminuted mixtures comprising heavy high-protein fractions and light high-oil fractions, separating the heavy high-protein fractions from the light high-oil fractions, and then separately further processing each of the heavy high-protein fractions and the light high-oil fractions to produce the plant protein concentrates. The methods disclosed herein avoid the use of organic solvents and high temperatures i.e. temperatures greater than 60° C.

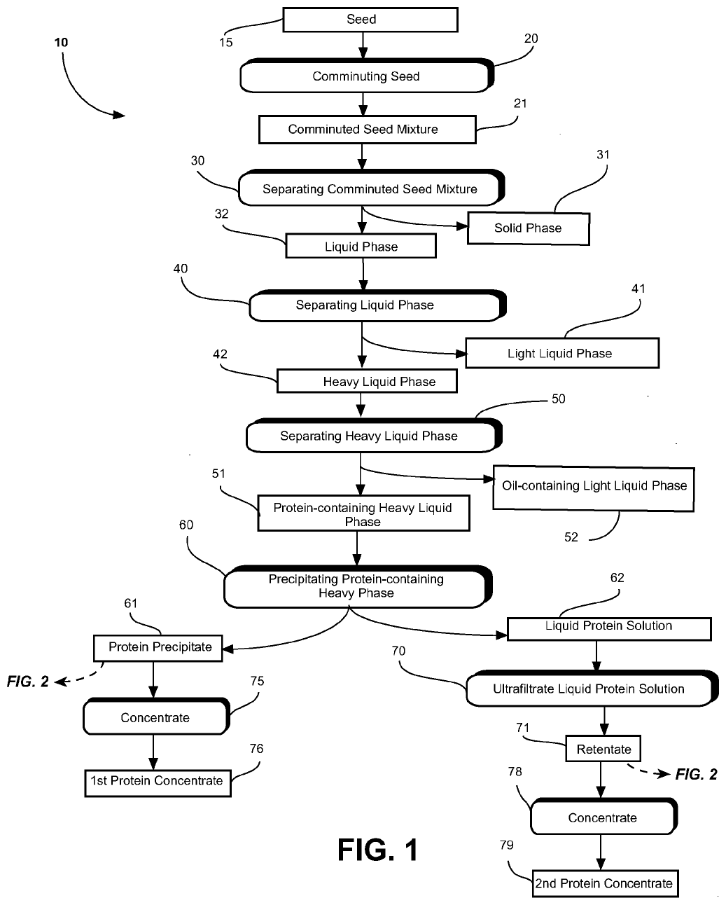

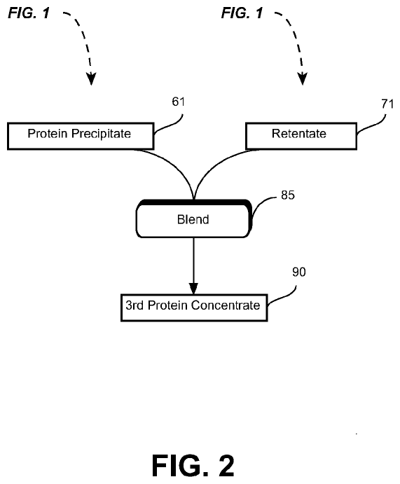

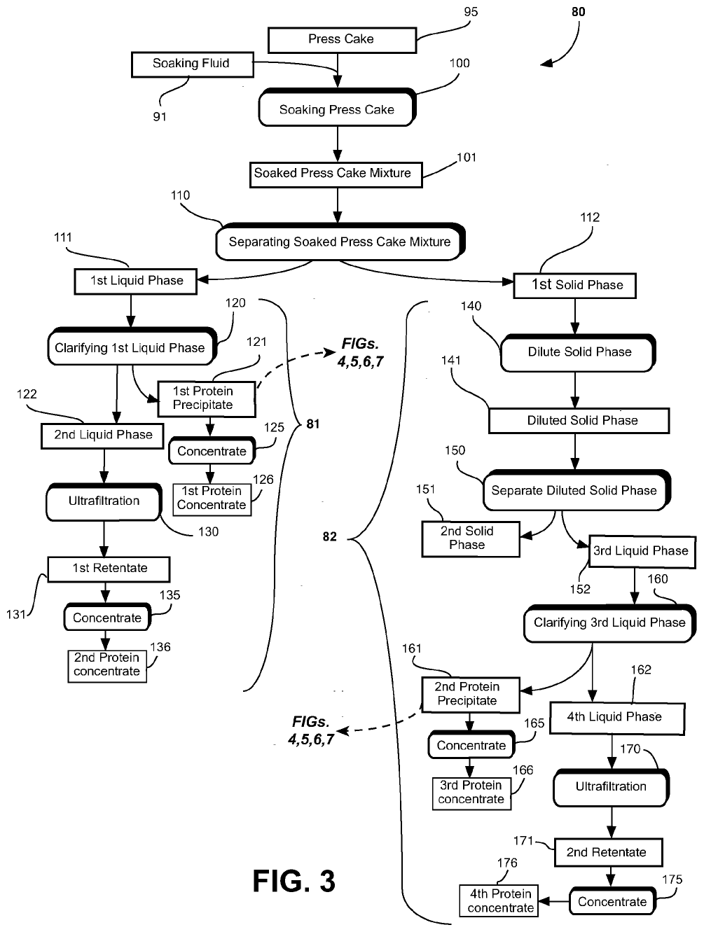

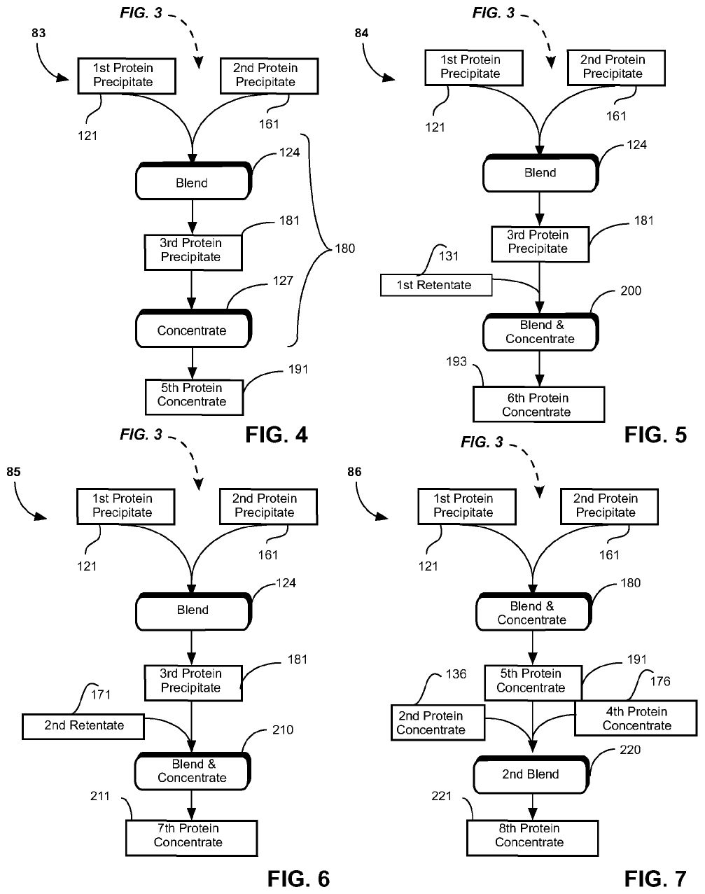

Various suitable techniques and methods for processing plant seed materials to produce therefrom the present plant protein concentrates are disclosed in the following sections. FIGS. 1, 2, and 3-7 illustrate schematic diagrams of example processes 10 (FIG. 1) and 80 (FIG. 3) for preparing plant protein concentrates in accordance with embodiments of the present disclosure.

Thus, referring now to FIG. 1, example process 10 starts with providing a quantity of plant seeds 15. Plant seeds 15 may be obtained for example, by agriculturally producing and harvesting seed, and/or by purchasing seed from a commercial seed supplier. Prior to proceeding with the comminuting step 20, the plant seeds 15 may optionally be screened and cleaned if necessary or so desired, to remove extraneous materials such as debris or non-intact seed material. Plant seeds 15 may also optionally be washed or surface-sterilized using for example, a chemical agent such as bleach, to reduce contaminating biological agents such as bacteria or fungi that may be present on the seed coats. In some embodiments, undesirable seed parts may be removed for example, the seed coating, the hull, or the husk may be removed using dehulling equipment and the like with which those of skill in this art will generally be familiar. Furthermore, plant seeds 15 may be soaked for a selected period of time for example, from about 30 minutes to about 24 hours for example, in water or in an aqueous solution having a pH of from about 9.0 to 9.5.

Continuing in reference to FIG. 1, example process 10 further comprises comminuting step 20 wherein whole plant seeds 15 whereby is produced a comminuted mixture of seed particles 21 preferably having particle sizes in a range of between about 5 μm and about 200 μm. Comminuting step 20 generally reduces the seed volume as well as the particle size of the comminuted seed. Step 20 may be carried out by conveying plant seeds 15 into a comminuting equipment such as a seed mill, a colloid mill, a hammer mill, a blade mill, a roller mill, and the like. In other embodiments, a homogenizer such as a high-pressure homogenizer, may be used to comminute plant seed 15. In yet other embodiments, a sequential combination of a mill and a homogenizer or other such equipment may be used to comminute the seed 15.

It should be noted, however, that in some embodiments, the use of a high-pressure homogenizer e.g. operating at 400 bar, may result in a first protein concentrate 76 or a second protein concentrate 79 having an oil content lower than about 4% oil or higher than about 10% oil, as documented later herein Example 1 and Example 2. However, combining the first protein concentrate 76 (or precipitate 61) and the second protein concentrate 79 (or retentate 71) may then still result in a protein concentrate having an oil content of from about 4% (w/w) to about 10% (w/w) plant oil, as hereinafter further described.

It should be further noted that the selection of the specific comminuting equipment and the operating conditions of the equipment may depend on the size of the selected plant seed 15. However, regardless of the comminuting equipment that is selected, upon completion of step 20, the comminuted seed particle mixture 21 will have mean particle sizes in a range of from about 5 μm to about 200 μm or from about 5 μm to about 100 μm, or mean particle sizes in a range of about 10 μm, about 25 μm, about 50 μm, about 100 μm, about 125 μm, about 150 μm, about 175 μm, about 200 μm, and therebetween. Preferably, the comminution equipment and conditions are selected so that the comminuted seed particles are homogenously sized, i.e. the particles can have tightly-centered mean-particle size, e.g. at least 90% of the particles can have a size not exceeding ±20% of the particle size, or not exceeding ±10% of the particle size, or not exceeding ±5% of the mean particle size. Furthermore, it should be noted that high temperatures i.e. temperatures in excess of 60° C. are avoided in the performance of comminuting step 20. Thus, comminuting step 20 may be conducted at ambient temperatures although it is understood that during operation of mechanical comminution equipment, the temperature of the seed mixture may increase above the ambient temperatures.

Comminuting step 20 may be carried out with the seed suspended in an aqueous solution. Examples of suitable aqueous solutions include water and dilute solutions comprising a sodium salt such as NaCl or alternatively, a strong acid such as Na₂SO₄. Examples of suitable dilute solutions may comprise about 50 mM of a sodium salt and/or about 50 mM of a strong acid. It is also suitable if so desired, to include a water-soluble surfactant such as polyethylene glycol in the aqueous solution for comminuting plant seed 15. The aqueous solution may be added to the plant seed 15 prior to conveyance into the comminuting equipment, or alternatively, while the plant seed 15 is being discharged from a seed bin or other seed storage containers into the comminuting equipment. As hereinbefore noted, the use of organic solvents during performance of the comminuting step 20 is avoided.

It is noted that in some embodiments, comminuting plant seeds in aqueous solutions comprising Na₂SO₄ may result in a first protein concentrate 76 or second protein concentrate 79 having an oil content lower than about 4% oil or higher than about 10% oil, as documented hereinlater in Example 2. However, combining the first protein concentrate 76 (or precipitate 61) and the second protein concentrate 79 (or retentate 71) may then still result in a protein concentrate having an oil content of from about 4% (w/w) to about 10% (w/w) plant oil, as hereinafter further described.

Continuing in reference to FIG. 1, example process 10 may further comprise a separation step 30 during which the comminuted seed particle mixture is separated into a solid phase 31 and a liquid phase 32. Thus, separation step 30 yields two seed fractions. The separation step 30 may be carried out by conveying the comminuted seed particle mixture 21 into equipment suitable for separating the comminuted seed particle mixture 21 based on density differentials. Suitable separation equipment includes for example, a centrifuge such as a two-phase decanter operated at modest gravitational forces that may be, for example, between about 2,700×g and about 3,400×g, to separate a light liquid phase 32 and a heavy solid phase 31 containing seed particle solids. The liquid phase 32 recovered after separation therefrom of the heavy solid phase 31, contains the majority of the seed oil, and the separated solid phase 31 contains solid seed particulate material including for example, seed hull particles.

The recovered solid phase 31 may contain from about 5% (w/w) to about 25% (w/w) of the total seed oil, and from about 25% (w/w) to about 35% (w/w) of the total seed protein. The recovered liquid phase 32 may contain from about 75% (w/w) to about 95% (w/w) of the seed oil, and from about 65% (w/w) to about 75% (w/w) of the seed protein. Furthermore, the recovered solid phase 31 may contain from about 3% (w/w) to about 6% (w/w) of seed oil, from about 5% (w/w) to about 8% (w/w) of seed protein, from about 10% (w/w) to about 15% (w/w) carbohydrate, about 1% (w/w) ash, and from about 70% (w/w) to about 80% (w/w) moisture. The recovered liquid phase 32 may contain from about 6% (w/w) to about 10% (w/w) of seed oil, from about 2% (w/w) to about 4% (w/w) of seed protein, from about 1% (w/w) to about 2.5% (w/w) carbohydrate, from about 0.4% to about 1% (w/w) ash, and from about 82% (w/w) to about 89% (w/w) moisture.

Continuing in reference to FIG. 1, example process 10 may further comprise step 40 during which the liquid phase 32 is separated into a light liquid phase 41 and a heavy liquid phase 42. Step 40 may be achieved by conveying the liquid phase 32 into separation equipment capable of further separating the liquid phase 32 based on density differential for example, a low-shear centrifuge operated at gravitational forces of from about 10,000×g to about 15,000×g. The recovered light liquid phase 41 may contain from about 75% (w/w) to about 90% (w/w) of the total seed oil, and from about 30% (w/w) to about 40% (w/w) of the total seed protein. The recovered heavy liquid phase 42 may contain from about 2% (w/w) to about 4% (w/w) of the total seed oil, and from about 30% (w/w) to about 40% (w/w) of the total seed protein. The light liquid phase 41 may contain from about 20% (w/w) to about 28% (w/w) seed oil, from about 3% (w/w) to about 5% (w/w) protein, from about 1.5% (w/w) to about 2% (w/w) carbohydrate, from about 0.5% (w/w) to about 1% (w/w) ash, and from about 65% to about 75% moisture. The heavy liquid phase 42 may contain from about 0.2% (w/w) to about 0.7% (w/w) seed oil, from about 2% (w/w) to about 4% (w/w) protein, from about 0.7% (w/w) to about 1.5% (w/w) carbohydrate, from about 0.5% (w/w) to about 1% (w/w) ash, and from about 92% to about 96% moisture.

It should be noted that steps 30 and 40 may be performed concurrently by using a single-density differential-based separation equipment such as a 3-phase decanter that is capable of separating the comminuted seed particle mixture into a solid phase, a heavy liquid phase, and a light liquid phase.

Continuing in reference to FIG. 1, example process 10 may further comprise step 50 comprising separating the heavy liquid phase 42 to obtain therefrom a protein-containing heavy liquid phase 51 and an oil-containing light liquid phase 52. This may be achieved by further density differential-based separation of the heavy liquid phase 42, conveniently by gravitational settling therefrom of the protein-containing heavy liquid phase 51, for example, at room temperature in a settling tank or by using a lamellar liquid-liquid separator to form the protein-containing heavy liquid phase 51 and the oil-containing light liquid phase 52. In some embodiments, in order to facilitate settling of the protein-containing heavy liquid phase 51, additives may be included therewith. Suitable additives for this purpose include sulfite salts such as sodium sulfite, sodium bisulfite, and sodium metabisulfite, and/or surfactants such as polyethylene glycol, sodium dodecyl sulfate, TWEEN® (TWEEN is a registered trademark of Croda International PLC, Snaith, Great Britain) and urea, and/or carbohydrate-degrading enzymes such as cellulose, and the like. The protein-containing heavy liquid phase 51 thus obtained may contain from about 0.5% (w/w) to about 1.2% (w/w) of the total seed oil, and from about 25% (w/w) to about 35% (w/w) of the total seed protein. The oil-containing light liquid phase 52 may contain from about 1.5% (w/w) to about 3% (w/w) of the total seed oil and from about 3% (w/w) to about 6% (w/w) of the total seed protein. The protein-containing heavy liquid phase 51 may contain less than about 0.3% (w/w) seed oil, from about 2% (w/w) to about 3% (w/w) protein, from about 0.7% (w/w) to about 2% (w/w) carbohydrate, from about 0.3% (w/w) to about 1% (w/w) ash, and from about 95% (w/w) to about 97% (w/w) moisture. The oil-containing light liquid phase 52 may contain from about 3% (w/w) to about 5% (w/w) seed oil, from about 2% (w/w) to about 4% (w/w) protein, from about 0.5% (w/w) to about 2% (w/w) carbohydrate, from about 0.3% (w/w) to about 0.7% (w/w) ash, and from about 90% to about 93% moisture.

Continuing in reference to FIG. 1, example process 10 may further comprise step 60 comprising separating the protein-containing heavy liquid phase 51 to recover therefrom a protein precipitate 61, and a liquid protein solution 62. Step 60 maybe performed by acidifying the protein-containing heavy liquid phase 51 to a pH from about 3.5 to about 4.0 using for example, phosphoric acid. The acid-precipitated protein may be separated from the liquid protein solution 62, for example, by feeding the acid-treated material into a clarifier centrifuge at between about 11,500×g and 12,200×g and recovering therefrom a solid protein preparation in the form of a protein precipitate 61, and a liquid protein solution 62. In at least one embodiment, the protein precipitate 61 may be concentrated (step 75) by drying the protein precipitate 61, for example, to provide a first protein concentrate 76 that comprises at least about 65% (w/w) plant protein, from about 4% (w/w) to about 15% (w/w) plant oil and therebetween, and from about 0.1% (w/w) to about 10% (w/w) carbohydrates and therebetween.

Continuing in reference to FIG. 1, example process 10 may further comprise step 70 comprising processing the liquid protein solution 62 by ultrafiltration and recovering therefrom a retentate 71. The ultrafiltration equipment used may vary and may have a membrane unit having a molecular weight cut-off 20 kDa or less, 10 kDa or less, or 5 kDa or less. Optionally, in addition to being treated by ultrafiltration, the protein solution may also be processed by diafiltration.

The recovered retentate 71 may then be concentrated (step 78) to produce a concentrated protein solution comprising about 25% to about 30% (w/w) protein. The concentrated protein solution may then be further spray dried to produce a second protein concentrate 79 having a moisture content of from about 5% to about 10% (w/w).

The second protein concentrate 79 may comprise from at least about 65% (w/w) plant protein, from about 0.1% (w/w) to about 5% (w/w) plant oil, and from about 0.5% (w/w) to about 15% (w/w) carbohydrates.

The moisture content of the retentate 71 and/or the protein precipitate 61 may be modulated by controlling the drying process for example by extending or decreasing the drying time and/or by increasing or decreasing the drying temperature. In this manner, substantially dry first protein concentrate 79 or second protein concentrate 76 with varying moisture contents may be obtained. For example, the dried first and/or the second protein concentrates 76, 79 may have a moisture content from the range of about 4% (w/w) to about 10% (w/w).

Furthermore, according to some embodiments, some of the retentate 71 and the protein precipitate 61 may be combined and blended 85 to obtain a third protein concentrate 90 as illustrated in FIG. 2.

According to some embodiments, the plant protein concentrates may be prepared from processed plant materials such as, for example, seed cakes, press cakes, seed meals, non-toasted solvent-extracted press-cakes, and the like. Example process 80 illustrated in FIG. 3, comprises example subprocesses 81 and 82 (FIG. 3) and optionally, may further comprise one or more example subprocesses 83 (FIG. 4), 84 (FIG. 5), 85 (FIG. 6), and/or 86 (FIG. 7) for use to recover and further process plant protein concentrates from such processed plant materials.

Referring now to FIG. 2, example process 80 may begin with providing a press cake 95. The press cake 95 may be obtained, for example, by initially agriculturally producing and harvesting seed and processing seed by pressing seed material to (i) remove the seed liquids i.e. the seed oil, and (ii) retain the remaining seed solids thereby forming a press cake. Pressing may be achieved by any device that can provide sufficient more or less continuous pressure to remove seed oil from the seed. Examples of suitable pressing devices include but are not limited to, hydraulic presses and screw-type oil expellers configured to press seeds through a barrel using a rotating screw installed within the barrel. The particle sizes comprising the press cake may vary and preferably are in a range of, for example, about 100 mm to about 3,000 mm. In general, the seed moisture condition is kept relatively high i.e., in a range from about 7% to about 10%, because it known that press cakes having lower moisture contents i.e., below 7%, comprise particle sizes having diameters less than 100 mm.

It should be noted that pressing conditions are most preferably selected to avoid temperatures in excess of 60° C. Therefore, in one embodiment, a press cake may be obtained by ‘cold pressing’ seed material, i.e. pressing seed material under conditions in which no supplemental heat is provided.

Further processing of the press cake may optionally include extraction in the presence of organic solvents provided that: (i) the solvent is removed following extraction, and (ii) the solvent does not substantively negatively affect the extractability and/or the quality of the plant protein. Thus, in the case that organic solvents are used for further processing of the press cake, it is preferred that the temperatures used during extraction and subsequent removal of the organic solvent, do not exceed 60° C. Accordingly, further processing of the press cake may optionally include extraction in the presence of supercritical carbon dioxide.

Continuing in reference to FIG. 2, example process 80 may further comprise step 100 comprising the addition of a soaking fluid 91 such as water, to the press cake 95 to produce a soaked press-cake mixture 101. Step 100 may generally be carried out by combining the press cake 95 with a selected soaking fluid 91 in a suitable receptacle, tank, or container that is dimensioned to contain therein the press cake 95 and the soaking fluid 91. The period of time during which soaking is performed may be varied. In general, soaking is performed for at least 2 hours and generally not longer than 48 hrs. Soaking may generally conveniently be carried out at ambient temperatures. Furthermore, the soaked-press cake mixture 101 may be periodically or continuously gently stirred to produce a more or less homogenous slurry.

Continuing in reference to FIG. 2, example process 80 may further comprise step 110 wherein the soaked press-cake mixture 101 is separated into two fractions comprising a first liquid phase 111 and a first solid phase 112. Step 110 may generally be carried out by conveying the soaked press-cake mixture 101 into equipment capable of separating the soaked press-cake mixture 101 on a density differential basis. Suitable equipment includes, for example, a centrifuge such as a two-phase decanter that may be operated at modest gravitational forces in a range between about 2,700×g and about 3,400×g, to produce therefrom the first liquid phase 111 and the first solid phase 112 containing seed solids. The first liquid phase 111 generally comprises the majority of the seed oil from the press cake 95. The first solid phase 112 generally comprises solid seed cake material, including among other things, seed hull particulate matter. Both of the first liquid phase 111 and the first solid phase 112 comprise plant protein. The first liquid phase 111 may contain from about 45% (w/w) to about 55% (w/w) of the press-cake oil, and from about 45% (w/w) to about 55% (w/w) of the press-cake protein. The first solid phase 112 may comprise from about 45% (w/w) to about 55% (w/w) of the total press-cake oil and from about 45% (w/w) to about 55% (w/w) of the total press-cake protein. The first liquid phase 111 may contain from about 0.3% (w/w) to about 0.4% (w/w) of seed oil, from about 4% (w/w) to about 6% (w/w) of seed protein, from about 1.8% (w/w) to about 1.9% (w/w) carbohydrate, from about 0.5% to about 0.7% (w/w) ash, and from about 92% (w/w) to about 94% (w/w) moisture. Furthermore, the first solid phase 112 may contain from about 0.7% (w/w) to about 0.8% (w/w) of seed oil, from about 9% (w/w) to about 11% (w/w) of seed protein, from about 16% (w/w) to about 18% (w/w) carbohydrate, from about 1.5% (w/w) to about 1.8% (w/w) ash, and from about 68% (w/w) to about 80% (w/w) moisture.

Continuing in reference to FIG. 2, the first liquid phase 111 may be processed in accordance with example subprocess 81 that additionally comprises steps 120 and 130, and the first solid phase 112 may be processed in accordance with example subprocess 82 that additionally comprises one or more of steps 140, 150, 160 and 170.

In order to initiate example subprocess 81, the first liquid phase 111 may be clarified (step 120) and then separated into a second liquid phase 122 and a first protein precipitate 121. Step 120 may be accomplished using, for example, a clarifier centrifuge operated at between about 11,500×g and 12,200×g to thereby produce the first protein precipitate 121 and the second liquid phase 122. The recovered first protein precipitate 121 may be concentrated (step 125) to produce a first protein concentrate 126 comprising about 25% to about 30% (w/w) protein. The first protein concentrate 126 may optionally be further spray dried, thereby reducing its moisture content to a range of from about 5% to about 10% (w/w).

Example subprocess 81 may further include step 130 comprising processing the second liquid phase 122 by ultrafiltration and recovering therefrom a first protein retentate 131. Prior to the ultrafiltration step, the pH of the second liquid phase 122 may be adjusted if so desired, to a pH from about 6.0 to about 9.0. The ultrafiltration equipment used may vary and may have a membrane unit with a molecular weight cut-off of about 20 kDa or less, 10 kDa or less, or 5 kDa or less. In addition to processing by ultrafiltration, the second liquid phase 122 may also be processed by diafiltration. The recovered first protein retentate 131 may be concentrated (step 135) to produce a second protein concentrate 136 comprising about 25% to 30% (w/w) protein. The second protein concentrate 136 may be further spray dried to a moisture content from a range of about 5% to about 10% (w/w).

The recovered second protein concentrate 136 may comprise about 65% (w/w) or more plant protein, from about 4% (w/w) to about 10% (w/w) plant oil, and from about 0.1% (w/w) to about 15% (w/w) carbohydrates.

Continuing in reference to FIG. 2, example subprocess 82 may comprise a first step 140 where in the first solid phase 112 is diluted to produce a diluted solid phase 141. Step 140 may be performed by mixing the first solid phase 112 in an aqueous mixing solution, for example water, in a suitable mixing vessel. It is optional if so desired, to increase the pH of the first solid phase 112 during the mixing step to about pH 10 or pH 11 or therebetween. The mixing period may vary and may be selected from a range of about 2 hrs to about 24 hrs. In general, step 140 may be performed at ambient temperatures. The diluted solid phase 141 may be described as a slurry. It is to be noted that if the pH is not increased during the mixing step, the final pH of the diluted solid phase 141 may decrease to slightly acidic pH values.

Next, step 150 of example subprocess 82 may comprise separating the diluted solid phase 141 to produce a third liquid phase 152 and a second solid phase 151. Step 150 may generally be carried out by conveying the diluted solid phase 141 into equipment suitable for separating the diluted solid phase 141 on a density-differential basis. An example of such suitable equipment includes a centrifuge such as a two-phase decanter operated at modest gravitational forces between about 2,700×g and about 3,400×g to separate the second solid phase 151 and the third liquid phase 152. The recovered second solid phase 151 may contain from about 23% (w/w) to about 25% (w/w) of the total press-cake oil and from about 22% (w/w) to about 28% (w/w) of the total press-cake protein. The recovered third liquid phase 152 may contain from about 14% (w/w) to about 27% (w/w) of the press-cake oil, and from about 18% (w/w) to about 23% (w/w) of the press-cake protein. Furthermore, the second solid phase 151 may contain from about 0.4% (w/w) to about 0.6% (w/w) of seed oil, from about 5% (w/w) to about 7% (w/w) of seed protein, from about 15% (w/w) to about 18% (w/w) carbohydrate, from about 1.6% (w/w) to about 1.9% (w/w) ash, and from about 68% (w/w) to about 80% (w/w) moisture. The third liquid phase 152 may contain from about 0.1% (w/w) to about 0.3% (w/w) of seed oil, from about 2% (w/w) to about 3% (w/w) of seed protein, from about 0.7% (w/w) to about 1.0% (w/w) carbohydrate, from about 0.7% to about 1.0% (w/w) ash, and from about 95% (w/w) to about 96% (w/w) moisture.

Continuing to FIG. 2, step 160 of example subprocess 82 may be performed by clarifying the third liquid phase 152 and separating therefrom a fourth liquid phase 162 and a second protein precipitate 161. Step 160 may be performed using for example, a clarifier centrifuge operated at between about 11,500×g and 12,200×g to thereby separate the second protein precipitate 161, and the fourth liquid phase 162. The recovered second protein precipitate 161 may be concentrated (step 165) to produce a third protein concentrate 166 comprising about 25% to about 30% (w/w) protein. The third protein concentrate 166 may optionally be spray dried to a moisture content of about 5% to about 10% (w/w). It should be noted that prior to initiating step 160, the pH of the third liquid phase 152 may be adjusted from a slight acidic pH to a basic pH for example, to about pH 9.0.

Example subprocess 82 may further include step 170 comprising processing the fourth liquid phase 162 by ultrafiltration and recovering therefrom a second protein retentate 171. Prior to ultrafiltration, the pH of the fourth liquid phase 162 may optionally be adjusted to a pH from about 6.0 to about 9.0. The ultrafiltration equipment used may vary and may include a membrane unit having a molecular weight cut-off of 20 kDa or less, 10 kDa or less, or 5 kDa or less. Optionally, in addition to processing by ultrafiltration, the fourth liquid phase 162 may also be processed by diafiltration. The recovered second protein retentate 171 may be further concentrated (step 175) to produce a fourth protein concentrate 176 comprising about 25% to about 30% (w/w) protein. The fourth protein concentrate 176 may optionally be spray dried to a moisture content of about 5% to about 10% (w/w). The fourth protein concentrate 176 may comprise about 65% (w/w) or more plant protein, from about 4% (w/w) to about 10% (w/w) plant oil, and from about 0.1% (w/w) to about 15% (w/w) carbohydrates.

Referring now to FIG. 4, in one embodiment, example subprocess 83 may include step 180 wherein the first protein precipitate 121 and the second protein precipitate 161 are combined and blended (step 124) to form a third protein precipitate 181, and then concentrated (step 127) to produce a fifth protein concentrate 191 comprising from about 65% (w/w) or more plant protein, from 4 about 4% (w/w) to about 10% (w/w) plant oil, and from about 0.1% (w/w) to about 15% (w/w) carbohydrates.

Referring now to FIG. 5, in one embodiment, example subprocess 84 may include step 180 wherein the first protein precipitate 121 and the second protein precipitate 161 are combined and blended (step 124) to form a third protein precipitate 181 that may be combined and blended with the first retentate 131 and concentrated (step 200) to thereby produce a sixth protein concentrate 193 comprising from 65% (w/w) or more plant protein, from about 4% (w/w) to about 10% (w/w) plant oil, and from about 0.1% (w/w) to about 15% (w/w) carbohydrates.

Referring now to FIG. 6, in one embodiment, example subprocess 85 may include step 180 wherein the first protein precipitate 121 and the second protein precipitate 161 are combined and blended (step 124) to form a third protein precipitate 181 that may be combined and blended with the second retentate 171 and concentrated (step 210) to thereby produce a seventh protein concentrate 211 comprising from about 65% (w/w) or more plant protein, from about 4% (w/w) to about 10% (w/w) plant oil, and from about 0.1% (w/w) to about 15% (w/w) carbohydrates.

Referring now to FIG. 7, in one embodiment, example subprocess 86 may additionally include step 220 wherein the fifth protein concentrate 191 produced in step 180 (FIG. 4), may be combined and blended with the second protein concentrate 136 and the fourth protein concentrate 176 to produce an eighth protein concentrate 221 comprising from about 65% (w/w) or more plant protein, from about 4% (w/w) to about 10% (w/w) plant oil, and from about 0.1% (w/w) to about 15% (w/w) carbohydrates.

To briefly recap, the example processes 10 and 80 may each provide selectable protein precipitates and selectable protein retentates, each of which may be selectively concentrated to form prepared protein concentrates. The selected retentates and selected precipitates may differ somewhat in their relative quantities of constituents, notably in their protein, oil, carbohydrates, and ash contents. The prepared protein precipitates may comprise from about 65% (w/w) or more plant protein, from about 4% (w/w) to about 15% (w/w) plant oil, and from about 0.1% (w/w) to about 10% (w/w) carbohydrates.

The selected protein precipitates and selected retentates disclosed herein may each comprise from 65% (w/w) or more plant protein, and from about 4% (w/w) to about 15% (w/w) carbohydrates.

In some embodiments, the protein precipitates and/or the retentates disclosed herein may comprise proteins in the form of polyphenol-protein complexes. The protein precipitates and/or the retentates may further comprise polyphenols wherein up to 85% of the polyphenols exist as free polyphenols.

Phosphate-buffered saline solutions of the protein precipitates and/or the retentates may comprise proteins having sedimentation coefficients of predominantly 1.7S, 2.5S and 12S.

In other embodiments, only a portion of the aforementioned precipitates or the retentates obtained may be used and the quantities of the precipitate and the retentate used for blending may vary, for example from about 10% (w/w) to about 90% (w/w) of the precipitate may be blended with from about 90% (w/w) down to about 10% (w/w) of the concentrate to form a mixture, and a subsequent protein blend upon drying.

By blending various quantities of retentates and precipitate concentrates, the relative amounts of constituents in a blended protein concentrate may be adjusted as desired. Thus, by way of example only, if a precipitate concentrate containing protein in an amount of 70% (w/w) is produced, and a retentate concentrate containing protein in an amount of 82% (w/w) is produced, and it is desirable to produce a protein concentrate containing protein in an amount of 76% (w/w), equal quantities of the retentate and the precipitate protein concentrates may be blended. In this manner, as will be clear, it is possible to obtain protein concentrates comprising, or comprising about, comprising at least, or comprising at least about 65% (w/w), 66% (w/w), 67% (w/w); 68% (w/w); 69% (w/w); 70% (w/w); 71% (w/w); 72% (w/w); 73% (w/w); 74% (w/w); 75% (w/w); 76% (w/w); 77% (w/w); 78% (w/w); 79% (w/w); 80% (w/w); 81% (w/w); 82% (w/w); 83% (w/w); 84% (w/w); or 85% (w/w) or more protein. It is noted that those skilled in this art will understand that the protein content in a preparation produced as disclosed herein, can readily be measured by various methodologies known to the art including for example among others, the Kjeldahl method, methods for determining measuring nitrogen by combustion disclosed in the Association of Official Analytical Chemists (AOAC) Method 992.23, and methods disclosed in the American Association of Cereal Chemists (AACC) Method 46-30, 1999.

The amounts of oil and carbohydrate in the final protein concentrates may in a similar manner, be selected and adjusted by blending various selected amounts of retentate and precipitated protein concentrates to thereby obtain a prepared protein concentrate having a desired amount of oil and/or a desired amount of carbohydrate.

Thus, in some embodiments, a protein concentrate comprising plant oil in an amount varying between about 4% (w/w) and about 10% (w/w) and therebetween, may be prepared.

In some embodiments, a protein concentrate comprising carbohydrate in an amount varying between about 0.5% (w/w) and 15% (w/w) and therebetween, may be prepared.

Another embodiment of the present disclosure relates to processes for producing plant protein concentrates from whole plant seeds, wherein the processes comprise:
(ii) providing whole plant seeds;
(ii) comminuting the plant seeds in an aqueous solution to obtain a mixture comprising comminuted plant seed particles having mean particle sizes in a range of about 5 μm to about 200 μm;
(iii) separating the mixture into a solid phase and a liquid phase;
(iv) separating the liquid phase into a light liquid phase and a heavy liquid phase;
(vi) separating the heavy liquid phase to recover therefrom a protein-containing heavy liquid phase and an oil-containing light liquid phase;
(vi) precipitating protein from the protein-containing heavy liquid phase thereby producing a solid protein precipitate and a liquid protein solution (in reference to method 10).

According to one aspect, the present methods may additionally comprise a step (vii) of concentrating the solid first protein precipitate from step (vi) to produce a first protein concentrate (in reference to method 10).

According to another aspect, the present methods may additionally comprise a step (viii) of treating the liquid protein solution by ultrafiltration to obtain a first retentate and a step (ix) of concentrating the retentate to produce a second protein concentrate (in reference to method 10).

Yet another embodiment of the present disclosure relates to processes for producing plant protein concentrates from press cakes produced from whole plants, wherein the methods comprise (in reference to method 80):
(i) providing a press cake;
(ii) soaking the press cake in a selected aqueous solution thereby providing a more or less homogenous mixture of soaked press cake;
(iii) separating the soaked press cake mixture into a first liquid phase and a first solid phase;
(iv) separating the first liquid phase into a first protein precipitate and a second liquid phase, wherefrom the first protein precipitate is concentrated into a first protein concentrate (in reference to subprocess 81);
(v) separating a first retentate from the second liquid phase and then concentrating the first retentate to produce a second protein concentrate (in reference to subprocess 81);
(vi) diluting the first solid phase and then separating the diluted first solid phase into a second solid phase and a third liquid phase (in reference to subprocess 82);
(vii) separating the third liquid phase into a second protein precipitate and a fourth liquid phase, wherefrom the second protein precipitate may be concentrated to produce a third protein concentrate (in reference to subprocess 82); and
(viii) recovering a second retentate from the fourth liquid phase and concentrating said retentate to produce a fourth protein concentrate (in reference to subprocess 82).

According to one aspect, the present methods may additionally comprise a step (ix) of blending the first protein precipitate from step (iv) with the second protein precipitate from step (vii) to produce a blended third protein precipitate and concentrating the blended third protein precipitate to produce a fifth protein concentrate (in reference to FIG. 4).

According to one aspect, the present methods may additionally comprise a step (x) of blending the first protein precipitate from step (iv) with the second protein precipitate from step (vii) to produce a blended third protein precipitate and adding the first retentate from step (v) and blending and concentrating to produce a sixth protein concentrate (in reference to FIG. 5). According to one aspect, the present methods may additionally comprise a step (xi) of blending the first protein precipitate from step (iv) with the second protein precipitate from step (vii) to produce a blended third protein precipitate, then adding the second retentate from step (viii) and blending and concentrating the mixture to produce a seventh protein concentrate (in reference to FIG. 6). According to one aspect, the present methods may additionally comprise a step (xii) of blending the first protein precipitate from step (iv) with the second protein precipitate from step (vii) to produce a blended third protein precipitate and concentrating the blended third protein precipitate to produce a fifth protein concentrate and adding the second protein concentrate of step (v) and the fourth protein concentrate of step (viii) to produce a blend which is an eighth protein concentrate (in reference to FIG. 7).

It is to be noted that the processes disclosed herein may be modified by those skilled in these arts whereby the steps generally disclosed in regard to example process 80 and subprocesses 81, 82 (FIG. 3) wherein press cake was used as the starting material, can be adapted for processing whole plant seeds as generally disclosed in example process 10 (FIG. 1), and conversely.

The protein concentrates of the present disclosure may be prepared without exposing the starting plant materials to high temperatures or to solvents. Thus, the plant proteins recovered by the fractionation processes described herein will not have sustained any heat damage or solvent damage. As a result, protein concentrates disclosed herein may be light colored, relatively odorless, and bland in taste. Furthermore, the plant proteins within the various plant protein concentrates described herein may be substantially non-denatured and may retain their primary and/or their secondary and/or their tertiary three-dimensional structures.

The protein concentrates produced with the processes disclosed herein may be rich in essential amino acids and may, for example, have weight percentages of amino acids in excess of at least about 30% by weight of crude protein.

Another embodiment of the present disclosure relates to protein concentrates comprising weight percentages of essential amino acids of at least about 35% by weight crude protein.

Another embodiment of the present disclosure relates to protein concentrates comprising weight percentages of essential amino acids of at least about 40% by weight crude protein.

According to an aspect, the weight percentages of lysine in the protein concentrates may be at least about 3.0% by weight crude protein.

According to another aspect, the weight percentages of lysine in the protein concentrates may be at least about 5.0% by weight crude protein.

According to another aspect, the weight percentages of lysine in the protein concentrates may be at least about 7.0% by weight crude protein.

The protein concentrates disclosed herein may comprise proteins that may be substantially digestible. Accordingly, protein concentrates disclosed herein may comprise proteins that may be at least about 75% digestible, at least about 80% digestible, at least about 90% digestible, at least about 95% digestible, or at least about 99% digestible, when ingested by mammals, fowl, and fish, among others.

Furthermore, all of the essential amino acids that may be present in the protein concentrates disclosed herein may be at least about 80% digestible, at least about 85% digestible, at least about 90% digestible, at least about digestible, at least 95% digestible, or at least about 99% digestible. For example, arginine may be up to about 100% digestible or from at least about 93% to about 100% digestible; histidine may be up to about 100% digestible or from at least about 92% to about 100% digestible; isoleucine may be up to at least about 93% digestible, or from at least about 84% to at least about 93% digestible; leucine may be up to at least about 94% digestible or from at least about 83% to at least about 94% digestible; lysine may be up to at least about 96% digestible or from at least about 90% to at least about 96% digestible; methionine may be up to about 100% digestible or from at least about 94% to about 100% digestible; phenylalanine may be up to at least about 95 digestible or from at least about 85% to at least about 95% digestible; threonine may be up to at least about 97% digestible or from at least about 84% to at least about 97% digestible; tryptophan may be up to about 100% digestible or from at least about 95% to about 100% digestible; and valine may be up to at least about 95% digestible or from at least about 80% to at least about 95% digestible.

The protein concentrates produced with the processes disclosed herein may also be substantially free of various anti-nutritional constituents including those from a group comprising glucosinolates, polyphenols, tannins, sinapine, stachyose, phytate, insoluble non-starch polysaccharides, and the like.

The term “substantially free” as used herein with respect to anti-nutritional constituents, means that the protein concentrates contain less than about 7.5% (w/w), less than about 5% (w/w), 3% (w/w), less than about 2% (w/w), less than about 1% (w/w), less than about 0.5% (w/w), or less than about 0.1% (w/w) anti-nutritional compounds. In a protein concentrate that is substantially free of anti-nutritional constituents, the concentrations of the anti-nutritional constituents are so low that any presence thereof has no substantive negative impact on the health, the growth, or the development of a subject when a protein concentrate disclosed herein is included in the subject's diet.

According to some aspects, the protein concentrates may contain less than 0.6 μmole/g glucosinolates.

According to some aspects, the protein concentrates may contain less than 4.5% (w/w) polyphenols.

According to some aspects, the protein concentrates may contain less than 0.15% (w/w) tannins.

According to some aspects, the protein concentrates may contain less than 1.5% (w/w) sinapine.

According to some aspects, the protein concentrates may contain less than 7.5% (w/w) phytate.

According to some aspects, the protein concentrates may contain less than 4.5% (w/w) insoluble non-starch polysaccharides.

According to some embodiments of the present disclosure, protein concentrates produced by the processes described herein may be used as ingredients in nutritional formulations. In order to prepare the nutritional formulations, one or more of the protein concentrates disclosed herein may be contacted with or blended with or mixed together with at least one other formulary ingredients suitable for use to prepare a nutritional product composition. Furthermore, at least one other formulary ingredient may be provided in any suitable form such as for example, a solution, a suspension, a gel, a liquid, a solid, a powder, a crystal, and the like. The quantity of the at least one other formulary ingredient may vary and may depend on the type of nutritional formulation that is being prepared. Furthermore, a plurality of additional formulary ingredients may be provided, for example 2, 3, 4, 5, 6, 7, 8, 9, 10 or more formulary ingredients to prepare the nutritional formulation.

In some embodiments, a formulation suitable for inclusion in a nutritional product comprising a mixture of formulary ingredients may be pre-formed, and the protein concentrate may be separately provided and incorporated into the pre-formed formulary ingredient mixture.

In some embodiments, the protein concentrate may be incorporated during preparation of the nutritional formulation. In such embodiments, the protein concentrate may be added separately or alternatively, the protein concentrate may be incorporated together with one or more other formulary compounds.

The final concentration of the protein concentrate in the nutritional product may vary. In some embodiments, the protein concentrate may comprise at least about 10% (w/w) of the nutritional formulation. In other embodiments, the protein concentrate may comprise at least about 20% (w/w), at least about 30% (w/w), at least about 40% (w/w), at least about 50% (w/w), at least about 60% (w/w), at least about 70% (w/w), at least about 80% (w/w), or at least about 90% (w/w) of the nutritional formulation. The concentration of the protein concentrate may be optimized or adjusted by preparing a plurality of sample nutritional formulations, wherein each formulation comprises a different concentration of the protein concentrate, then evaluating each of the formulations with reference to one or more nutritional effects, then selecting one or more of the formulations to provide a selected desirable effect.

In some embodiments, the additional formulary ingredient incorporated in the nutritional formulations of the present disclosure may be a natural ingredient. Since the protein concentrates disclosed herein are natural compositions, in some embodiments, the nutritional formulations may be formulated using additional natural formulary ingredients thereby providing one or more natural nutritional formulations.

In some embodiments, the additional formulary ingredient may be a synthetic ingredient.

According to some embodiments of the present disclosure, the protein compositions prepared with the processes disclosed herein may be used to prepare nutritional formulations for use as fish feed compositions or aquaculture compositions.

Fish feed formulations generally comprise mixtures of ingredients selected to provide fish requisite ingredients including proteins, fats, carbohydrates, vitamins and minerals. Fish require nutritionally balanced diets prepared for their growth, development, and health requirements during and throughout their life cycles. Fish and aquaculture formulations according to some embodiments of the present disclosure may be specifically formulated for selected types of fish and aquatic species, selected stages of their lifecycles (e.g. juvenile stages or adult stages), feeding preferences (e.g. carnivorous or herbivorous), preferred environmental conditions (e.g. salt water, fresh water, tropical temperatures, cold water temperatures), and rearing systems (e.g. sea pens, fresh-water ponds, land-based recirculation facilities). Ingredients which may be included to prepare fish feed formulations according to the present disclosure include marine ingredients, land-animal co-ingredients, vegetable ingredients, grain ingredients, vitamins, minerals, carotenoids, attractants, and binders. Examples of suitable marine ingredients include fishmeal and fish oil from wild-caught fish, farm-raised fish, or marine trimming sources. Fish meal is a high-protein ingredient often comprising fish trimmings or small bony fish. Fish oil ingredients may be sourced from fish trimmings or small bony fish. Fish oil ingredients provide energy and may also provide long-chain omega-3 fatty acids that are essential for fish health. Examples of suitable land-animal co-ingredients poultry, cattle, pig and sheep ingredients such as poultry meal, feather meal, meat meal, blood meal, poultry oil, and the like. Land-animal protein ingredients may be used high-quality sources of protein. For example, poultry meals have similar amino acid profiles to fish meal thereby providing poultry meals as suitable replacements for fish meals. It should be noted that while poultry oil may be used as energy, it generally has a relatively low content of omega-3 fatty acids. Examples of suitable vegetable and grain ingredients include wheat and its derivatives, soya protein concentrates, lupin meals, faba bean meal, and canola oil. Vegetable ingredients such as wheat gluten, lupin meal, soya protein concentrates, and the like may be used as sources of protein in fish feed formulations and aquaculture formulations, in accordance some embodiments of the present disclosure. Fish feeds are generally preferably designed to provide a balanced amino acid profile and therefore, mixtures of different vegetable proteins may be used. Wheat and faba bean may also be included as sources of carbohydrates. Carbohydrates may also be included as binders in the manufacturing of fish feed to formulations and aquaculture formulations to provide compositional stability and to prevent minimal disintegration of formulations upon their addition to water. Other binders that may be included in the present formulations are wheat gluten and gelatin among others. Carbohydrates may also be included to provide compositional durability, and to avoid fracturing of the compositions when the fish feed formulations or the aquaculture formulations are conveyed by and through mechanical feeding systems to fish rearing and/or aquaculture rearing facilities.

It should be noted that fish oil ingredients in the fish food formulations and aquaculture formulations, may be substituted with canola oil to decrease levels of saturated fats in the feed formulations to improve the digestibility of fats and provision of energy sources in in cold-water rearing environments. The vitamin and mineral ingredients used in fish feed formulations are similar to those used in supplements for humans. The vitamin and mineral ingredients may be added to fish feed formulations and aquaculture feed formulations to provide reared fish with the nutrients required for their optimal growth, development, and health.

Examples of suitable carotenoids that may be included in the present fish feed formulations and aquaculture formulations are astaxanthin and canthaxanthin. Astaxanthin is a naturally occurring carotenoid that wild salmon extract from crustaceans that they feed on to lay down muscle tissue and also, are transported to the eggs during the breeding cycle of large salmonids. Since it is known that salmon are not able to synthesize astaxanthin, nature-identical astaxanthin may be added to the present fish feed formulations and aquaculture feed formulations. Carotenoids are also important ingredients in the present fish feed formulations and aquaculture feed formulations as they have powerful antioxidant properties. Examples of suitable attractants that may be included in the present fish feed formulations and aquaculture feed formulations are crustacean meals and/or krill meals. Adding attractants to the present fish feed formulations and aquaculture feed formulations may approve the acceptability of fish feed thereby increasing the intake of feeds and improving growth rates. Examples of suitable binders for addition into the present fish feed formulations and aquaculture feed formulations include wheat gluten and gelatin.

In accordance with the foregoing, the present disclosure provides another embodiment relating to methods for preparing nutritional formulations comprising the plant protein concentrates disclosed herein, wherein the methods comprise:
(i) providing a plant protein concentrate comprising at least about 65% (w/w) or more plant protein, from about 4% (w/w) to about 10% (w/w) plant oil, from about 0.5% (w/w) to about 15% (w/w) carbohydrates, the balance of the protein concentrate substantially being constituted by water and ash;
(ii) providing one or more formulary ingredients suitable for inclusion into a nutritional formulation; and
(iii) formulating the plant protein concentrate with the formulary ingredient by blending or mixing to produce a nutritional formulation comprising the plant protein concentrate.

Another embodiment of the present disclosure relates to use of a plant protein concentrate disclosed herein as an ingredient for preparing a nutritional formulation, wherein the plant protein concentrate comprises at least about 65% (w/w) or more plant protein, from about 4% (w/w) to about 10% (w/w) plant oil, from about 0.5% (w/w) to about 15% (w/w) carbohydrates, the balance of the protein concentrate substantially being constituted by water and ash.

Another embodiment of the present disclosure relates to a nutritional formulation comprising a plant protein concentrate comprising at least about 65% (w/w) or more plant protein, from about 4% (w/w) to about 10% (w/w) plant oil, from about 0.5% (w/w) to about 15% (w/w) carbohydrates, the balance of the protein concentrate substantially being constituted by water and ash.

Some nutritional formulations incorporating the protein concentrates disclosed herein may be suitable for use as an animal feed. Some nutritional formulations incorporating the protein concentrates disclosed herein may be suitable for use as a fish feed or an aquaculture feed. Some nutritional formulations incorporating the protein concentrates disclosed herein may be suitable for human consumption. Some nutritional formulations incorporating the protein concentrates disclosed herein may be suitable for use as a poultry feed or a pig feed or a companion animal feed or a feed formulation for juvenile animals.

### EXAMPLES

Hereinafter are provided examples of further specific embodiments for performing the methods of the present disclosure, as well as embodiments representing the compositions of the present disclosure.

### Example 1: Preparation and Characterization of a First Protein Concentrate, and a Second Protein Concentrate Obtained by Blending the First Protein Concentrate and a Retentate

This example is provided in reference to process 10 depicted in FIG. 1 and related subprocess 85 in FIG. 2.

120 kg clean (<1% dockage) Brassica napus seeds 15 having 47.2% oil content, and 19.7% protein content were soaked in 150 kg reverse osmosis-treated water (RO-water) for 16 hours at ambient room temperature. After completion of the soaking period, the weight of the soaked seeds was determined to be 195 kg, an increase of 75 kg due to absorption of water. The soaked seeds were concurrently conveyed with a supply of RO-water warmed to 48° C. (11 kg/min), by a coil auger at an average rate of 4.5 kg/min for 43 min to a Fitzpatrick hammer mill, wherein was produced an aqueous slurry of wet-milled seed having an eventual seed:water ratio of 1:4.6. The particle size of milled-seed slurry was immediately reduced by processing at an average rate of 15 kg/min through sequential rotor-stator homogenizer equipment wherein the first equipment was a FrymaKoruma colloid mill (Romaco Inc., Pompton Plains, N.J., USA) and the second equipment was an IKA MK colloid mill (IKA Works Inc., Wilmington, N.C., USA. The resulting homogenized slurry was collected in a hold tank, and then further processed at an average rate of 3.2 kg/min for 210 minutes through a Rannie high-pressure homogenizer operating at a pressure of about 400 bar (40,000 kPa). The final homogenized slurry (i.e. comminuted seed particle mixture 21) was conveyed at an average rate of 3.2 kg/min into a centrifuge decanter (Alfa Laval, NX-912) which imparted a force of 3,000×g on the final homogenized slurry to enable separation of the solid phase 31 and the liquid phase 32. Separation of the final homogenized slurry in the decanter occurred in 213 minutes. The average particle size under these conditions may be deduced to be less than about 200 μm, and, likely, less than 100 μm, and larger than 5 μm in view of the fact that the plant cells (generally not exceeding 200 μm or 100 μm) were ruptured, while oleosome structures (generally not exceeding 5 μm) remained intact. The solid phase 31 (112 kg) was a first co-product of process 10 and had a dry-basis composition: 16% (w/w) oil, 26% (w/w) protein, 4% (w/w) ash and 54% (w/w) carbohydrate. The liquid phase 32 (502 kg) comprising a mixture of liquefied seed components, was separated in a two-phase disc-stack separator (Westfalia, SA20-01) under a force of 13,225×g at an average rate of 5.5 kg/min. The resulting oleosome-rich light liquid phase 41 (172 kg) comprised the majority of the seed oil (>65%), leaving the protein recovery pathway relatively fat-free thereby facilitating production of low-fat protein concentrates. The corresponding heavy liquid phase 42 (317 kg) had the following dry-basis composition: 19% (w/w) oil, 49% (w/w) protein, 5% (w/w) ash and 27% (w/w) carbohydrate. In order to further reduce the oil to protein ratio in heavy liquid phase 42, gravitational settling over the course of 120 minutes provided a further oil-containing light liquid phase 52 (32 kg) and a protein-containing heavy liquid phase 51 (284 kg), The protein-containing heavy liquid phase 51 had the following dry-basis composition: 11% (w/w) oil, 56% (w/w) protein, 5% (w/w) ash and 28% (w/w) carbohydrate. The pH of protein-containing heavy liquid phase 51 was adjusted from 5.8 to 3.62 by the addition of 0.7 L of phosphoric acid (85% v/v), The resulting mixture was processed in a clarifier centrifuge (Wesifalia, SA7-06) at an average rate of 5.8 kg/min over the course of 50 minutes under a force of 11,800×g to separate and produce therefrom a protein precipitate 61 and a liquid protein solution 62. The protein precipitate 61 (32 kg) was dried to produce a first protein concentrate 76 with the following composition: 7.1% (w/w) oil, 76.7% (w/w) protein, 7.3% (w/w) carbohydrate, 5.5% (w/w) ash and 3.4% (w/w) moisture. The liquid protein solution 62 was processed by ultrafiltration using a 10-kDa molecular weight cut-off membrane (Synder Filtration) to recover therefrom a retentate 71 (27 kg). The retentate 71 was then dried to produce a second protein concentrate 79 with the following composition: 0.6% (w/w) oil, 76.9% (w/w) protein, 11.5% (w/w) carbohydrate, 4.4% (w/w) ash and 6.6% (w/w) moisture. The protein precipitate 61 (32 kg) and 23 kg of the retentate 71 may be combined and concentrated (step 85) to produce 55 kg of a protein mixture which may then be dried to provide the following composition: 4.0% (w/w) oil, 76.8% (w/w) protein, 9.3% (w/w) carbohydrate, 5.0% (w/w) ash and 4.9% (w/w) moisture.

### Example 2: Preparation and Characterization of a Protein Concentrate Blend

This example is provided in reference to process 10 depicted in FIG. 1 and related subprocess 85 in FIG. 2.

240 kg clean (<1% dockage) Brassica napus seeds 15 having 47.2% oil content and 19.7% protein content, were soaked in 300 kg RO-water for 16 hours at ambient room temperature. After completion of the soaking period, the weight of the soaked seeds was determined to be 390 kg, an increase of 150 kg due to absorption of water. The soaked seeds were concurrently conveyed with a supply of RO water warmed to 48° C. (10 kg/min) and an ambient room temperature 6.7% and an aqueous solution of Na₂SO₄ (0.8 kg/min), by a coil auger at an average rate of 3.9 kg/min for 100 min to a Fitzpatrick hammer mill, wherein was produced an aqueous slurry of milled seed having an eventual seed:water ratio of 1:5.1. The particle size of the milled-seed slurry was immediately reduced by processing at an average rate of 15 kg/min through sequential rotor-stator homogenizer equipment wherein the first equipment was a FrymaKoruma colloid mill and the second equipment was an IKA MK colloid mill. The resulting homogenized slurry was collected in a hold tank, and then further processed at an average rate of 5.6 kg/min for 260 minutes through a Rannie high-pressure homogenizer operated at a pressure of about 400 bar (40,000 kPa). The final homogenized slurry (i.e. comminuted seed particle mixture 21) was conveyed at an average rate of 7.2 kg/min into a centrifuge decanter (Alfa Laval, NX-912), which imparted a force of 3,000×g on the final homogenized slurry to enable separation of the solid phase 31 and the liquid phase 32. Separation of the final homogenized slurry in the decanter occurred in 205 minutes.

In this example, the solid phase 31 (234 kg) was the first co-product of process 10 and had a dry-basis composition: 16% oil, 26% protein, 4% ash and 54% carbohydrate. The liquid phase 32 (1,076 kg) comprising a mixture of liquefied seed components, was processed in a two-phase disc-stack separator (Wesifalia, SA20-01) under a force of 13,225×g, at an average rate of 5.5 kg/min to separate and recover therefrom an oleosome-rich light liquid phase 41 and protein-containing heavy liquid phase 42. The oleosome-rich light liquid phase 41 (379 kg) comprised the majority of the seed oil (>75%), leaving the protein recovery pathway relatively fat-free thereby facilitating production of low-fat protein concentrates. The protein-containing heavy liquid phase 42 (686 kg) had the following dry-basis composition: 6.2% (w/w) oil, 54.8% (w/w) protein, 14.8% (w/w) ash and 24.2% (w/w) carbohydrate. In order to further reduce the oil to protein ratio in the heavy liquid phase 42, gravitational settling over the course of 120 minutes provided a further oil-containing light liquid phase 52 (69 kg) and a protein-containing heavy liquid phase 51 (617 kg). The protein-containing heavy liquid phase 51 had the following dry-basis composition: 5.8% (w/w) oil, 55.2% (w/w) protein, 15.3% (w/w) ash and 23.8% (w/w) carbohydrate. The pH of the protein-containing heavy liquid phase 51 was adjusted from 6.0 to 3.62 by the addition of 2.5 L of phosphoric acid (85% v/v). The resulting mixture was processed in a clarifier centrifuge (Wesifalia, SA7-06) at an average rate of 5.8 kg/min over the course of 106 minutes under a force of 11,800×g to separate and recover therefrom a protein precipitate 61 and liquid protein solution 62. The protein precipitate 61 (58.5 kg) was dried to produce a first protein concentrate 76 with the following composition: 14.1% (w/w) oil, 70.6% (w/w) protein, 0.2% (w/w) carbohydrate 11.3% (w/w) ash and 3.8% (w/w) moisture. The liquid protein solution 62 was processed by ultrafiltration using a 5-kDa molecular weight cut-off membrane (Synder Filtration) to recover therefrom the retentate 71 (70 kg). The retentate 71 was dried to produce a second protein concentrate 79 with the following composition: 1.7% (w/w) oil, 74.1% (w/w) protein, 13.4% (w/w) carbohydrate, 6.3% (w/w) ash and 4.5% (w/w) moisture. The protein precipitate 61 (58.5 kg) and the retentate 71 (70 kg) may be combined in their entirety to produce 128.5 kg of a protein mixture which may be dried (step 85) to give the third protein concentrate 90 which has the following composition: 7.4% (w/w) oil, 72.3% (w/w) protein, 7.3% (w/w) carbohydrate, 8.6% (w/w) ash and 4.5% (w/w) moisture.

### Example 3: Amino Acid Profile and Anti-Nutritional Factor Characterization

This example is provided in reference to process 10 depicted in FIG. 1 and related subprocess 85 in FIG. 2.

240 kg clean (<1% dockage) Brassica napus seeds 15 having 47.2% oil content, and 19.7% protein content, were soaked in 300 kg RO-water for 16 hours at ambient room temperature. After completion of the soaking period, the weight of the soaked seeds was determined to be 390 kg, an increase of 150 kg due to absorption of water. The soaked seeds were concurrently conveyed with a supply of RO-water warmed to 48° C. (4 kg/min), by a coil auger at an average rate of 1.7 kg/min for 228 min to a Fitzpatrick hammer mill, wherein was produced an aqueous slurry of milled seed having an eventual seed:water ratio of 1:4.4. The particle size of milled-seed slurry was immediately reduced by processing at an average rate of 15 kg/min through sequential rotor-stator homogenizer equipment wherein the first equipment was a FrymaKoruma colloid mill and the second equipment was an IKA MK colloid mill. The resulting homogenized slurry was collected in a hold tank, and then further processed at an average rate of 4.8 kg/min for 271 minutes through a Rannie high-pressure homogenizer operating at a pressure of about 250 bar (25,000 kPa). The final homogenized slurry (i.e. comminuted seed particle mixture 21) was conveyed at an average rate of 5 kg/min into a centrifuge decanter (Alfa Laval, NX-912), which imparted a force of 3,000×g on the final homogenized slurry to enable separation of the solid phase 31 and the liquid phase 32. Separation of the final homogenized slurry in the decanter occurred in 263 minutes.

In this example, the solid phase 31 (261 kg) was the first co-product of process 10 and had a dry-basis composition: 19% oil, 26% protein, 4% ash and 51% carbohydrate. The liquid phase 32 (1,005 kg) comprising a mixture of liquefied seed components, was processed in a two-phase disc-stack separator (Westfalia, SA20-01) under a force of 13,225×g, at an average rate of 4.3 kg/min to separate and recover therefrom an oleosome-rich light liquid phase 41 and protein-containing heavy liquid phase 42. The oleosome-rich light liquid phase 41 (344 kg) comprised the majority of the seed oil (>75%), leaving the protein recovery pathway relatively fat-free thereby facilitating production of low-fat protein concentrates. The protein-containing heavy liquid phase 42 (649 kg) underwent settling under natural gravity to minimize the oil to protein ratio in heavy liquid phase 42. Gravitational settling over the course of 120 minutes provided a further oil-containing light liquid phase 52 (65 kg) and a heavy liquid phase 51 (584 kg). The pH of heavy liquid phase 51 was adjusted from 5.1 to 3.58 by the addition of 1.35 L of phosphoric acid (85% v/v). The resulting mixture was processed in a clarifier centrifuge (Westfalia, SA7-06) at an average rate of 6.5 kg/min over the course of 90 minutes under a force of 11,800×g to separate and recover therefrom a first protein precipitate 61 and a liquid protein solution 62. The first protein precipitate 61 (38 kg) was concentrated (step 75) by drying to produce a first protein concentrate 76 (80.5% crude protein) with the amino acid profile shown in Table 1 and an anti-nutritional composition shown in Table 2. The liquid protein solution 62 was processed by ultrafiltration using a 5-kDa molecular weight cut-off membrane (Synder Filtration) to recover a retentate 71 (77 kg). The retentate 71 was dried to produce a second protein concentrate 79 (73.1% crude protein) with an amino acid profile shown in Table 3 and an anti-nutritional composition shown in Table 4.

TABLE 1
First protein concentrate 76

| | % As-is | % of Crude |
|---|---|---|
| Amino Acids: | basis | Protein |
| Alanine | 3.18 | 3.95 |
| Arginine | 5.73 | 7.12 |
| Aspartic Acid | 7.93 | 9.85 |
| Glutamic Acid | 15.66 | 19.45 |
| Cysteine | 0.67 | 0.83 |
| Glycine | 4.23 | 5.25 |
| Histidine | 2.38 | 2.96 |
| Isoleucine | 2.98 | 3.70 |
| Leucine | 5.56 | 6.91 |
| Lysine | 2.49 | 3.09 |
| Methionine | 1.11 | 1.38 |
| Phenylalanine | 3.31 | 4.11 |
| Proline | 3.80 | 4.72 |
| Serine | 4.07 | 5.06 |
| Threonine | 2.37 | 2.94 |
| Tryptophan | 1.34 | 1.66 |
| Tyrosine | 2.12 | 2.63 |
| Valine | 3.51 | 4.36 |

TABLE 2
First protein concentrate 76
Anti-Nutritional Factors:

| | |
|---|---|
| Phytate (%) | 3.03 |
| Glucosinolates (μmol/g) | 0.58 |
| Sinapine (%) | 0.83 |
| Tannins (%) | <0.05 |
| Total Polyphenols (%) | 1.32 |
| Non-starch Polysaccharides (NSPs) (%) | 0.75 |
| Soluble NSPs (%) | 0.34 |
| Insoluble NSPs (%) | 0.41 |
| Crude Fiber (%) | 1.05 |

TABLE 3
Second protein concentrate 79

| | % As-is | % of Crude |
|---|---|---|
| Amino Acids: | basis | Protein |
| Alanine | 2.73 | 3.73 |
| Arginine | 4.83 | 6.61 |
| Aspartic Acid | 4.47 | 6.11 |
| Glutamic Acid | 15.68 | 21.45 |
| Cysteine | 1.46 | 2.00 |
| Glycine | 3.29 | 4.50 |
| Histidine | 2.56 | 3.50 |
| Isoleucine | 2.33 | 3.19 |
| Leucine | 4.42 | 6.05 |
| Lysine | 3.89 | 5.32 |
| Methionine | 1.04 | 1.42 |
| Phenylalanine | 2.48 | 3.39 |
| Proline | 4.56 | 6.24 |
| Serine | 3.14 | 4.30 |
| Threonine | 1.97 | 2.69 |
| Tryptophan | 0.94 | 1.29 |
| Tyrosine | 1.36 | 1.86 |
| Valine | 2.89 | 3.95 |

TABLE 4
Second protein concentrate 79
Anti-Nutritional Factors:

| | |
|---|---|
| Phytate (%) | 2.14 |
| Glucosinolates (μmol/g) | 0.14 |
| Sinapine (%) | 1.28 |
| Tannins | <0.05 |
| Total Polyphenols (%) | 1.52 |
| Non-starch Polysaccharides (NSPs) (%) | 4.00 |
| Soluble NSPs (%) | 3.63 |
| Insoluble NSPs (%) | 0.37 |
| Crude Fiber (%) | 0.32 |

The protein precipitate 61 (38.1 kg) and the retentate 71 (77 kg) may be combined in their entirety to provide 115.1 kg of a protein mixture which may then be dried (step 85) to produce a third protein concentrate 90 (75.7% crude protein) with an amino acid profile shown in Table 5 and an anti-nutritional composition shown in Table 6.

TABLE 5
Protein Concentrate 90

| Amino | % As-is | % of Crude |
|---|---|---|
| Acids: | basis | Protein |
| Alanine | 2.89 | 3.81 |
| Arginine | 5.15 | 6.79 |
| Aspartic Acid | 5.70 | 7.44 |
| Glutamic Acid | 15.67 | 20.74 |
| Cysteine | 1.18 | 1.58 |
| Glycine | 3.62 | 4.77 |
| Histidine | 2.50 | 3.31 |
| Isoleucine | 2.56 | 3.37 |
| Leucine | 4.83 | 6.35 |
| Lysine | 3.39 | 4.53 |
| Methionine | 1.06 | 1.41 |
| Phenylalanine | 2.78 | 3.65 |
| Proline | 4.29 | 5.70 |
| Serine | 3.47 | 4.57 |
| Threonine | 2.11 | 2.78 |
| Tryptophan | 1.08 | 1.42 |
| Tyrosine | 1.63 | 2.14 |
| Valine | 3.11 | 4.10 |

TABLE 6
Protein Concentrate 90
Anti-Nutritional Factors:

| | |
|---|---|
| Phytate (%) | 2.46 |
| Glucosinolates (μmol/g) | 0.30 |
| Sinapine (%) | 1.12 |
| Tannins | <0.05 |
| Total Polyphenols (%) | 1.45 |
| Non-starch Polysaccharides (NSPs) (%) | 2.84 |
| Soluble NSPs (%) | 2.46 |
| Insoluble NSPs (%) | 0.38 |
| Crude Fiber (%) | 0.58 |

### Example 4: Preparation of a First Protein Concentrate, a Second Protein Concentrate, and a Protein Concentrate Blend, and Complete Characterization

This example is provided in reference to process 10 depicted in FIG. 1 and related subprocess 85 in FIG. 2.

150 kg clean (<1% dockage) Brassica napus seeds 15 having 45.1% oil content, and 21.7% protein content, were soaked in 180 kg RO-water for 16 hours at ambient room temperature. After completion of the soaking period, the weight of the soaked seeds was determined to be 244 kg, an increase of 94 kg due to absorption of water. The soaked seeds were conveyed with a supply of RO-water warmed to 48° C. (7 kg/min), by a coil auger at an average rate of 2.8 kg/min for 88 min to a Fitzpatrick hammer mill, wherein was produced an aqueous slurry of milled seed having an eventual seed:water ratio of 1:4.8. The particle size of milled-seed slurry was immediately reduced by processing at an average rate of 10 kg/min through sequential rotor-stator homogenizer equipment wherein the first equipment was a FrymaKoruma colloid mill, the second equipment was an IKA dispax mill, and the third equipment was an IKA MK colloid mill. The final homogenized slurry (i.e. comminuted seed particle mixture 21) was conveyed at an average rate of 10.1 kg/min into a centrifuge decanter (Alfa Laval, NX-912) which imparted a force of 3,000×g on the final homogenized slurry to enable separation of the solid phase 31 and the liquid phase 32. Separation of the final homogenized slurry in the decanter occurred in 86 minutes.

In this example, the solid phase 31 (170 kg) was the first co-product of process 10 and had a dry-basis composition: 37% oil, 23% protein, 3% ash and 38% carbohydrate. The liquid phase 32 (631 kg) comprising a mixture of liquefied seed components, was processed in a two-phase disc-stack separator (Westfalia, SA20-01) under a force of 13,225×g, at an average rate of 7.3 kg/min to separate and recover therefrom an oleosome-rich light liquid phase 41 and protein-containing heavy liquid phase 42. The oleosome-rich light liquid phase 41 (126 kg) comprised the majority of the seed oil (>60%), leaving the protein recovery pathway relatively fat-free thereby facilitating production of low-fat protein concentrates. The protein-containing heavy liquid phase 42 (494 kg) had the following dry-basis composition: 19% (w/w) oil, 54% (w/w) protein, 6% (w/w) ash, and 21% (w/w) carbohydrate. In order to further reduce the oil to protein ratio in the heavy liquid phase 42, a 90-min gravitational settling resulted in an oil-rich light liquid phase 52 (40 kg) and heavy liquid phase 51 (454 kg). The heavy liquid phase 51 comprised 6% (w/w) oil, 52% (w/w) protein, 15% (w/w) ash, and 27% (w/w) carbohydrate. The pH of heavy liquid phase 51 was adjusted from 5.6 to 3.6 by the addition of 1.6 L of phosphoric acid (85% v/v). The resulting mixture was processed in a clarifier centrifuge (Westfalia, SA7-06) at an average rate of 5.3 kg/min over the course of 85 minutes under a force of 11,800×g. A sample of the resulting protein precipitate 61 (14.2 kg) was dried to produce a first protein concentrate 76 that had a proximate composition, an amino-acid profile, and an anti-nutritional composition shown in Tables 7, 8, and 9, respectively.

TABLE 7
Protein precipitate 61
Composition

| | |
|---|---|
| Crude Protein (% dry matter) | 78.92 |
| Crude Protein (% as-is) | 74.50 |
| Moisture (%) | 5.60 |
| Crude Fat (%) | 5.82 |
| Crude Ash (%) | 9.42 |
| Carbohydrate (by difference) | 4.66 |

TABLE 8
Protein precipitate 61

| Amino | % As-is | % of Crude |
|---|---|---|
| Acids: | basis | Protein |
| Alanine | 3.60 | 4.83 |
| Arginine | 5.27 | 7.07 |
| Aspartic Acid | 7.60 | 10.20 |
| Glutamic Acid | 13.74 | 18.44 |
| Cysteine | 1.02 | 1.37 |
| Glycine | 4.13 | 5.54 |
| Histidine | 1.95 | 2.62 |
| Isoleucine | 3.56 | 4.78 |
| Leucine | 6.52 | 8.75 |
| Lysine | 3.55 | 4.77 |
| Methionine | 1.64 | 2.20 |
| Phenylalanine | 3.88 | 5.21 |
| Proline | 4.12 | 5.53 |
| Serine | 3.37 | 4.52 |
| Threonine | 3.24 | 4.35 |
| Tryptophan | 1.41 | 1.89 |
| Tyrosine | 2.37 | 3.18 |
| Valine | 4.33 | 5.81 |

TABLE 9
Protein precipitate 61
Anti-Nutritional Factors:

| | |
|---|---|
| Phytate (%) | 1.88 |
| Glucosinolates (μmol/g) | <0.05 |
| Tannins (%) | 0.08 |
| Total Polyphenols (%) | 3.77 |
| Non-starch Polysaccharides (NSPs) (%) | 1.12 |
| Soluble NSPs (%) | 0.72 |
| Insoluble NSPs (%) | 0.40 |
| Crude Fiber (%) | <0.2 |

The liquid protein solution 62 was processed by ultrafiltration using a 10 kDa molecular weight cut-off membrane (Alfa Laval, RC) to produce retentate 71 (62 kg). A portion of the retentate 71 was dried to produce a second protein concentrate 79 that had a proximate composition, an amino-acid profile, and an anti-nutritional composition shown in Tables 10, 11, and 12, respectively.

TABLE 10
Retentate 71
Composition

| | |
|---|---|
| Crude Protein (% dry matter) | 76.66 |
| Crude Protein (% as-is) | 73.06 |
| Moisture (%) | 4.70 |
| Crude Fat (%) | 5.06 |
| Crude Ash (%) | 10.32 |
| Carbohydrate (by difference) | 6.86 |

The protein precipitate 61 (13.2 kg) and the retentate 71 (57.6 kg) were blended together resulting in 70.8 kg of a protein mixture that was then dried (step 85) to produce a third protein concentrate 90 that had a proximate composition, an amino-acid profile, and an anti-nutritional composition shown in Tables 13, 14, and 15, respectively.

TABLE 11
Retentate 71

| Amino | % As-is | % of Crude |
|---|---|---|
| Acids: | basis | Protein |
| Alanine | 3.15 | 4.31 |
| Arginine | 4.73 | 6.47 |
| Aspartic Acid | 4.20 | 5.75 |
| Glutamic Acid | 16.42 | 22.47 |
| Cysteine | 2.28 | 3.12 |
| Glycine | 3.61 | 4.94 |
| Histidine | 2.27 | 3.11 |
| Isoleucine | 2.74 | 3.75 |
| Leucine | 4.99 | 6.83 |
| Lysine | 4.63 | 6.34 |
| Methionine | 1.59 | 2.18 |
| Phenylalanine | 2.75 | 3.76 |
| Proline | 5.52 | 7.56 |
| Serine | 2.87 | 3.93 |
| Threonine | 2.70 | 3.70 |
| Tryptophan | 1.11 | 1.52 |
| Tyrosine | 1.53 | 2.09 |
| Valine | 3.48 | 4.76 |

TABLE 12
Retentate 71
Anti-Nutritional Factors:

| | |
|---|---|
| Phytate (%) | 2.97 |
| Glucosinolates (μmol/g) | <0.05 |
| Tannins (%) | <0.05 |
| Total Polyphenols (%) | 4.06 |
| Non-starch Polysaccharides (NSPs) (%) | 5.13 |
| Soluble NSPs (%) | 4.85 |
| Insoluble NSPs (%) | 0.28 |
| Crude Fiber (%) | <0.2 |

TABLE 13
Third protein concentrate 90
Composition

| | |
|---|---|
| Crude Protein (% dry matter) | 77.11 |
| Crude Protein (% as-is) | 73.25 |
| Moisture (%) | 5.00 |
| Crude Fat (%) | 5.19 |
| Crude Ash (%) | 10.85 |
| Carbohydrate (by difference) | 5.71 |

TABLE 14
Third protein concentrate 90

| Amino | % As-is | % of Crude |
|---|---|---|
| Acids: | basis | Protein |
| Alanine | 3.28 | 4.48 |
| Arginine | 4.88 | 6.66 |
| Aspartic Acid | 5.03 | 6.87 |
| Glutamic Acid | 15.90 | 21.71 |
| Cysteine | 2.04 | 2.78 |
| Glycine | 3.75 | 5.12 |
| Histidine | 2.22 | 3.03 |
| Isoleucine | 2.94 | 4.01 |
| Leucine | 5.39 | 7.36 |
| Lysine | 4.36 | 5.95 |
| Methionine | 1.64 | 2.24 |
| Phenylalanine | 3.03 | 4.14 |
| Proline | 5.25 | 7.17 |
| Serine | 3.02 | 4.12 |
| Threonine | 2.86 | 3.90 |
| Tryptophan | 1.19 | 1.62 |
| Tyrosine | 1.74 | 2.38 |
| Valine | 3.73 | 5.09 |

TABLE 15
Third protein concentrate 90
Anti-Nutritional Factors:

| | |
|---|---|
| Phytate (%) | 2.12 |
| Glucosinolates (μmol/g) | <0.05 |
| Tannins (%) | <0.05 |
| Total Polyphenols (%) | 4.49 |
| Non-starch Polysaccharides (NSPs) (%) | 4.68 |
| Soluble NSPs (%) | 4.21 |
| Insoluble NSPs (%) | 0.47 |
| Crude Fiber (%) | <0.2 |

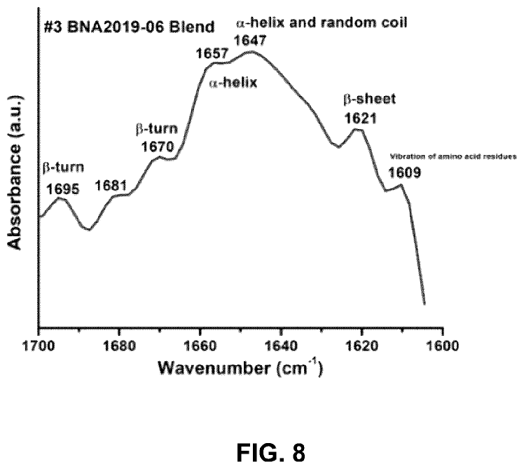

The canola protein concentrate 90 was dispersed in D₂O and analyzed by FTIR measurement. The spectrum of sample suspension was recorded using a Nicolet 6700 spectrophotometer (Thermal Fisher Scientific Inc., Pittsburgh, Pa., USA) in the range of wavenumber from 400 to 4000 cm⁻¹ during 128 scans with 4 cm⁻¹ resolution. The spectrophotometer was continuously purged with dry air from a lab gas generator (Parker Hannifin Corp., USA). For amide I band region (1700-1600 cm⁻¹), Fourier self-deconvolution was performed using Omnic 8.1 software. According the FTIR spectrum displayed in FIG. 8, the canola protein concentrate blend maintained most of the native protein secondary structures, as observed by the strong absorptions at: 1657 cm⁻¹ corresponding to an alpha-helix, 1670 cm⁻¹ corresponding to a beta-turn, 1695 cm⁻¹ corresponding to a beta-sheet.

### Example 5: Preparation and Characterization of a Protein Concentrate Blend

This example is provided in reference to process 80 depicted in FIG. 3 and related subprocesses 81 and 82 and to subprocesses 83 and 86 depicted in FIGS. 4, 5, 7.

200 kg of defatted Brassica napus press cake 95 having 3.1% oil content and 38.4% protein content, were soaked in 1,000 kg RO-water (i.e., soaking fluid 91) for 16 hours at room temperature with gentle agitation thereby forming a soaked press-cake slurry 101. Then, the soaked press-cake slurry 101 was conveyed at an average rate of 15.8 kg/min into a centrifuge decanter (Alfa Laval, NX-912) wherein was imparted a force of 3,000×g for about 76 min to separate the press-cake slurry 101 into a first solid phase 112 (403 kg) and a first liquid phase 111 (872 kg). The decanter was flushed with a further 75 kg of RO-water to maximise separation and recovery of the first solid phase 112 and the first liquid phase 111 from the decanter bowl.

In this example, the first solid phase 112 (403 kg) comprised on a dry-weight basis: 2% oil, 35% protein, 6% ash, and 57% carbohydrate.

The pH of the recovered first liquid phase 111 (872 kg) comprising a mixture of liquefied seed components, was increased from 6.0 to 9.0 with the addition of 1.4 L NaOH (50% w/v), and then was processed in a clarifier centrifuge (Westfalia, SA7-06) (step 120) at rate of 0.2 kg/min over the course of 7 hours under a force of 11,800×g to separate therefrom a first protein precipitate 121 (95 kg) and a second liquid phase 122 (774 kg). The pH of the second liquid protein solution 122 was increased to 9.0 with 150 mL of NaOH (50% w/v) after which, the pH-adjusted second liquid protein solution 122 was processed by ultrafiltration 130 with a 5-kDa molecular weight cut-off membrane (Synder Filtration) to produce 136 kg of a first retentate 131. The first retentate 131 was concentrated (step 135) by drying to produce a second protein concentrate 136 having a proximate composition, an amino acid profile, and an anti-nutritional composition shown in Tables 19, 20, and 21, respectively.

TABLE 19
Second protein concentrate 136
Composition

| | |
|---|---|
| Crude Protein (% dry matter) | 86.10 |
| Crude Protein (% as-is) | 82.75 |
| Moisture (%) | 3.90 |
| Crude Fat (%) | 3.86 |
| Crude Ash (%) | 2.32 |
| Carbohydrate (by difference) | 7.17 |

TABLE 20
Second protein concentrate 136

| Amino | % As-is | % of Crude |
|---|---|---|
| Acids: | basis | Protein |
| Alanine | 3.50 | 4.23 |
| Arginine | 5.53 | 6.68 |
| Aspartic Acid | 6.23 | 7.52 |
| Glutamic Acid | 18.81 | 22.73 |
| Cysteine | 2.47 | 2.98 |
| Glycine | 3.88 | 4.69 |
| Histidine | 2.35 | 2.84 |
| Isoleucine | 3.01 | 3.64 |
| Leucine | 5.72 | 6.91 |
| Lysine | 3.77 | 4.55 |
| Methionine | 2.01 | 2.43 |
| Phenylalanine | 2.90 | 3.50 |
| Proline | 4.85 | 5.86 |
| Serine | 3.92 | 4.73 |
| Threonine | 2.39 | 2.89 |
| Tryptophan | 1.09 | 1.32 |
| Tyrosine | 1.80 | 2.17 |
| Valine | 3.52 | 4.25 |

TABLE 21
Second protein concentrate 136
Anti-Nutritional Factors:

| | |
|---|---|
| Phytate (%) | 1.33 |
| Glucosinolates (μmol/g) | 0.39 |
| Sinapine (%) | 0.47 |
| Tannins (%) | 0 |
| Total Polyphenols (%) | 0.76 |
| Non-starch Polysaccharides (NSPs) (%) | 5.20 |
| Soluble NSPs (%) | 3.90 |
| Insoluble NSPs (%) | 1.30 |
| Crude Fiber (%) | 0 |

The first solid phase 112 (403 kg) was diluted with RO-water 140 (483 kg) to yield a diluted solid phase 141. The pH of the diluted solid phase 141 was increased from 5.95 to 10.83 by the addition of 7 kg of NaOH (50% w/v). The pH-adjusted diluted solid phase 141 was stirred for 21.5 hours at ambient room temperature during which time, the pH of the diluted solid phase 141 dropped from 10.83 to 6.22. Then, the pH-adjusted diluted solid phase 141 was conveyed at a rate of 15.8 kg/min into a centrifuge decanter (Alfa Laval, NX-912) which imparted a force of 3,000×g for about 56 minutes thereby separating therefrom, a second solid phase 151 (293 kg) and a third liquid phase 152 (603 kg). The second solid phase 151 (293 kg) was the first co-product of process 80 and had a dry-basis composition comprising 2% (w/w) oil, 26% (w/w) protein, 6% (w/w) ash, and 65% (w/w) carbohydrate. The pH of the recovered third liquid phase 152 comprising a mixture of liquefied seed components, was increased from 6.0 to 9.0 by the addition of 0.6 L NaOH (50% w/v). The pH-adjusted third liquid phase 152 was processed through a clarifier centrifuge 160 (Westfalia, SA7-06) at a rate of 0.2 kg/min over a 4-h period under a force of 11,800×g to produce a second protein precipitate 161 (58.9 kg) and a fourth liquid phase 162. The second protein precipitate 161 (58.9 kg) was blended with the first protein precipitate 121 (94.6 kg) as shown in FIG. 4 to produce a third protein precipitate 181 (153.5 kg) which was dried to produce a fifth protein concentrate 191 having a proximate composition, an amino acid profile, and an anti-nutritional composition shown in Tables 22, 23, and 24, respectively.

TABLE 22
Fifth protein concentrate 191
Composition

| | |
|---|---|
| Crude Protein (% dry matter) | 70.33 |
| Crude Protein (% as-is) | 66.25 |
| Moisture (%) | 5.80 |
| Crude Fat (%) | 5.89 |
| Crude Ash (%) | 12.31 |
| Carbohydrate (by difference) | 9.75 |

TABLE 23
Fifth protein concentrate 191

| Amino | % As-is | % of Crude |
|---|---|---|
| Acids: | basis | Protein |
| Alanine | 3.41 | 5.14 |
| Arginine | 4.67 | 7.04 |
| Aspartic Acid | 5.54 | 8.36 |
| Glutamic Acid | 11.39 | 17.19 |
| Cysteine | 1.75 | 2.64 |
| Glycine | 3.29 | 4.96 |
| Histidine | 1.83 | 2.76 |
| Isoleucine | 2.89 | 4.36 |
| Leucine | 5.16 | 7.78 |
| Lysine | 3.99 | 6.02 |
| Methionine | 2.41 | 3.63 |
| Phenylalanine | 2.87 | 4.33 |
| Proline | 3.51 | 5.29 |
| Serine | 3.61 | 5.44 |
| Threonine | 2.35 | 3.54 |
| Tryptophan | 0.91 | 1.37 |
| Tyrosine | 2.37 | 3.57 |
| Valine | 3.28 | 4.96 |

TABLE 24
Fifth protein concentrate 191
Anti-Nutritional Factors:

| | |
|---|---|
| Phytate (%) | 7.30 |
| Glucosinolates (μmol/g) | 0.49 |
| Sinapine (%) | 0.30 |
| Tannins (%) | 0.11 |
| Total Polyphenols (%) | 0.92 |
| Non-starch Polysaccharides (NSPs) (%) | 1.70 |
| Soluble NSPs (%) | 0.30 |
| Insoluble NSPs (%) | 1.40 |
| Crude Fiber (%) | 0.20 |

The fourth liquid phase 162 (543.6 kg) was processed by ultrafiltration (step 170) using a 5 kDa molecular weight cut-off membrane (Synder Filtration) to recover therefrom a second retentate 171 (65 kg). The second retentate 171 was concentrated by drying (step 175) to produce a fourth protein concentrate 176 (see: FIG. 3) having a proximate composition, an amino acid profile, and an anti-nutritional composition shown in Tables 25, 26, and 27, respectively.

TABLE 25
Fourth protein concentrate 176
Composition

| | |
|---|---|
| Crude Protein (% dry matter) | 84.23 |
| Crude Protein (% as-is) | 79.63 |
| Moisture (%) | 5.50 |
| Crude Fat (%) | 5.19 |
| Crude Ash (%) | 3.10 |
| Carbohydrate (by difference) | 6.58 |

TABLE 26
Fourth protein concentrate 176

| Amino | % As-is | % of Crude |
|---|---|---|
| Acids: | basis | Protein |
| Alanine | 3.71 | 4.66 |
| Arginine | 5.90 | 7.41 |
| Aspartic Acid | 6.08 | 7.64 |
| Glutamic Acid | 20.41 | 25.63 |
| Cysteine | 2.43 | 3.05 |
| Glycine | 4.00 | 5.03 |
| Histidine | 2.35 | 2.95 |
| Isoleucine | 3.05 | 3.81 |
| Leucine | 5.69 | 7.15 |
| Lysine | 5.54 | 6.96 |
| Methionine | 1.94 | 2.44 |
| Phenylalanine | 2.90 | 3.64 |
| Proline | 4.89 | 6.14 |
| Serine | 4.40 | 5.53 |
| Threonine | 2.62 | 3.29 |
| Tryptophan | 1.03 | 1.29 |
| Tyrosine | 2.15 | 2.70 |
| Valine | 3.51 | 4.41 |

TABLE 27
Fourth protein concentrate 176
Anti-Nutritional Factors:

| | |
|---|---|
| Phytate (%) | 1.18 |
| Glucosinolates (μmol/g) | 0.28 |
| Sinapine (%) | 0.17 |
| Tannins (%) | 0 |
| Total Polyphenols (%) | 0.85 |
| Non-starch Polysaccharides (NSPs) (%) | 5.60 |
| Soluble NSPs (%) | 4.20 |
| Insoluble NSPs (%) | 1.40 |
| Crude Fiber (%) | 0 |

Referring to FIG. 7, the first protein precipitate 121 and second protein precipitate 161 were also blended to form a third protein precipitate 181 (153.5 kg) (not separately shown in FIG. 7), and concentrated to form a fifth protein concentrate 191. The fifth protein concentrate 191 (10 kg) was then combined with the second protein concentrate 136 (9.9 kg) and the fourth protein concentrate 176 (3.7 kg), and then blended together (step 220, FIG. 7) produce an eighth protein concentrate 221 (23.6 kg) having a proximate composition, an anti-nutritional composition, and an amino acid profile, shown in Tables 28, 29, and 30, respectively.

TABLE 28
Eighth protein concentrate 221
Composition

| | |
|---|---|
| Crude Protein (% dry matter) | 79.22 |
| Crude Protein (% as-is) | 75.29 |
| Moisture (%) | 4.96 |
| Crude Fat (%) | 4.93 |
| Crude Ash (%) | 6.69 |
| Carbohydrate (by difference) | 8.18 |

TABLE 29
Eighth protein concentrate 221
Anti-Nutritional Factors:

| | |
|---|---|
| Phytate (%) | 3.84 |
| Glucosinolates (μmol/g) | 0.42 |
| Sinapine (%) | 0.35 |
| Tannins (%) | 0.05 |
| Total Polyphenols (%) | 0.84 |
| Non-starch Polysaccharides (NSPs) (%) | 3.78 |
| Soluble NSPs (%) | 2.42 |
| Insoluble NSPs (%) | 1.36 |
| Crude Fiber (%) | 0.08 |

TABLE 30
Eighth protein concentrate 221

| Amino | % As-is | % of Crude |
|---|---|---|
| Acids: | basis | Protein |
| Alanine | 3.53 | 4.69 |
| Arginine | 5.23 | 6.95 |
| Aspartic Acid | 5.95 | 7.90 |
| Glutamic Acid | 15.69 | 20.84 |
| Cysteine | 2.15 | 2.85 |
| Glycine | 3.66 | 4.86 |
| Histidine | 2.13 | 2.82 |
| Isoleucine | 2.99 | 3.97 |
| Leucine | 5.51 | 7.32 |
| Lysine | 4.18 | 5.55 |
| Methionine | 2.22 | 2.94 |
| Phenylalanine | 2.92 | 3.88 |
| Proline | 4.27 | 5.67 |
| Serine | 3.89 | 5.16 |
| Threonine | 2.43 | 3.23 |
| Tryptophan | 1.01 | 1.34 |
| Tyrosine | 2.15 | 2.85 |
| Valine | 3.44 | 4.57 |

### Example 6: Preparation of a Fish Feed Formulation Comprising a Protein Concentrate Blend

One or more protein concentrates prepared as described in Examples 1-5 may be formulated into a formulation or composition that is suitable for rearing fish. Examples of fish feed formulations wherein one or more protein concentrates disclosed herein having, for example, a 70% protein content, may comprise up 10% or 20% or 30% of the fish feed formulation. Such fish feed formulations are described below in comparison with a common prior art fish feed formulation referred to hereinafter as a “control”. Incorporation of the protein concentrates disclosed herein into fish feed formulations would facilitate reduction or elimination of fish meal and/or poultry by-product meal and/or corn gluten meal from fish feed formulations.

An example of ingredient list options for a fish food formulation is illustrated in Table 31. The dry ingredients are separately ground to similar particle sizes. A selected weight of each ingredient is added to a blending vessel, and then are thoroughly mixed to provide a homogenous mixture. A selected volume of one or more oils is then added to the homogenous mixture of dry ingredients, and then further blended to form a mash with a cake-like consistency. The mash mixture is conveyed through a pelletizing machine wherefrom pellets are extruded and cut at a selected length. The extruded pellets may be dried at a selected low temperature under a flow of air, to a moisture content of 10% or less.

TABLE 31
An ingredient list for an example of present fish food formulation

| Ingredients | | PC* | PC* | PC* |
|---|---|---|---|---|
| (g/kg) | Control | (10%) | (20%) | (30%) |
| Fish meal | 170 | 135 | 102 | 68 |
| (71% protein) | | | | |
| Poultry by-product meal | 210 | 193 | 176 | 158 |
| (67% protein) | | | | |
| Corn gluten meal | 170 | 112 | 55 | 0 |
| (60% protein) | | | | |
| CPC (70% protein) | 0 | 100 | 200 | 300 |
| Feather meal | 40 | 40 | 40 | 40 |
| (82% protein) | | | | |
| Canola oil | 60 | 60 | 60 | 60 |
| Fish oil | 80 | 86 | 91 | 97 |
| Wheat middlings | 150 | 153 | 154 | 155 |
| Cellulose | 21 | 21 | 22 | 22 |
| Methionine | 0.3 | 0.6 | 0.9 | 1.2 |
| Lysine | 21 | 21 | 21 | 21 |
| Choline | 3 | 3 | 3 | 3 |
| Vitamin premix | 10 | 10 | 10 | 10 |
| Mineral premix | 10 | 10 | 10 | 10 |
| Vitamin E | 6 | 6 | 6 | 6 |
| Ca(H₂PO₄)₂ | 10 | 10 | 10 | 10 |
| NaCl | 20 | 20 | 20 | 20 |
| ROVMIX ® STAY-C ®** | 3 | 3 | 3 | 3 |
| (25%) | | | | |

*PC: protein concentrate
**ROVMIX ® STAY-C ® is a spray-dried powder consisting of a stabilized (phosphorylated) Na/Ca salt of L-ascorbic acid. ROVMIX and STAY-C are registered trademarks of Koninklijke DSM N.V.

### Example 7: Nutritional Evaluation of a Canola Protein Concentrate Provided in Fish Food Formulations for Atlantic Salmon

A feeding trial was done to assess the effects of various fish food formulations comprising the protein concentrates disclosed herein, on the nutrition and growth juvenile salmon.

Four fish feed formulations were assessed in this trial: (i) a control feed formulation (designated “A”); (ii) a second feed formulation comprising 10% wt of a protein concentrate produced according to a method disclosed in Example 5 and designated “B”, a (iii) a third feed formulation comprising 20% wt of the protein concentrate and designated “C”, and (iv) a fourth feed formulation comprising 30% wt of the protein concentrate and designated “D”. The ingredient list for each of the 4 formulations is shown in Table 32. Each feed formulation was prepared as disclosed in Example 6 and was extruded through a co-rotating, intermeshing twin-screw cooking extruder (ZSK-57, Werner & Pfleiderer, Ramsey, N.J., USA) after which, the extruded pellets were coated with selected oils using a vacuum coater (UAS Canada Inc., Abbotsford, BC, CA).

The dry matter, protein, lipid, and gross energy contents of the 4 feed formulations are shown in Table 33, while their amino acids compositions are shown in Table 34.

The trial was conducted in a recirculating aquaculture system (RAS) equipped with 12 100-liter conical tanks containing fresh water amended with salt water to maintain salinity at about 10 ppt to prevent fungal infections. The water temperature was maintained at about 14.9±0.4° C. and dissolved oxygen was maintained at >90% saturation. Each of the 4 formulations was randomly allocated to 3 of the 12 tanks (i.e., 3 tanks/feed treatment).

The fish used in this trial were juvenile Atlantic salmon (from a St. John River strain) and as a group of 252 fish, had an average body weight of 57.3+6.7 g at the beginning of the trial. Each of the 12 tanks received 21 fish whereby each of the 4 treatments included a total of 63 fish.

TABLE 32

| | | | CPC level (% as-is) | | |
|---|---|---|---|---|---|
| | Ingredient | A | B | C | D |
| Code | Name | Control | (10%) | (20%) | (30%) |
| 55 | Monocalcium phosphate | 3.165 | 2.849 | 2.532 | 2.216 |
| | (21% P₂O₅) | | | | |
| 59 | BIOLYS ® * | 0.563 | 0.506 | 0.45 | 0.394 |
| 60 | DL Methionine | 0.126 | 0.113 | 0.101 | 0.088 |
| 300 | Fish oil herring | 15 | 13.5 | 12 | 10.5 |
| 320 | Vitamin & mineral Premix | 0.3 | 0.27 | 0.24 | 0.21 |
| 500 | Fishmeal herring | 20 | 18 | 16 | 14 |
| 510 | Poultry meal | 12.136 | 10.922 | 9.709 | 8.495 |
| | (pet food grade) | | | | |
| 515 | Blood meal | 7 | 6.3 | 5.6 | 4.9 |
| | (Spray-dried) | | | | |
| 550 | Soy protein concentrate | 5 | 4.5 | 4 | 3.5 |
| 561 | Corn protein concentrate | 10 | 9 | 8 | 7 |
| 565 | Wheat gluten meal | 7.845 | 7.061 | 6.276 | 5.492 |
| 567 | Wheat flour | 18.365 | 16.478 | 14.592 | 12.705 |
| | Canola protein concentrate | 0 | 10 | 20 | 30 |
| | Titanium dioxide | 0.5 | 0.5 | 0.5 | 0.5 |
| | | 100 | 100 | 100 | 100 |

* BIOLYS ® is a granulate producing containing a minimum 54.6% of lysine. BIOLYS is a registered trademark of Evonik Nutrition & Care GmbH.

TABLE 33

Nutrient composition (% as is)

| Feed | Dry | | | Gross |
|---|---|---|---|---|
| formulation | matter | Protein | Lipid | energy |
| A (Control) | 95.3 | 48.4 | 16.0 | 22.6 |
| B (10% CPC) | 94.3 | 52.4 | 14.7 | 21.9 |
| C (20% CPC) | 93.6 | 54.0 | 12.5 | 21.5 |
| D (30% CPC) | 94.9 | 57.5 | 12.1 | 21.8 |

The salmon were hand-fed to satiety 3 to 4 times daily, and (i) were initially fed the A-control fish feed formulation, (ii) then transitioned to their experimental diets allocated to their tanks over a 7-day period, after which (iii) the assigned fish feed formulations were provided 4 times daily for 5 days prior to the first collection of feces from each tank following the methods taught by Tibbetts et al. (2006, Aquaculture 261:1314-1327).

TABLE 34

| | Amino acid composition (% as is) | | | | |
|---|---|---|---|---|---|
| Diet | THR | VAL | MET | ILE | LEU |
| A Control | 1.85 | 2.74 | 1.13 | 2.09 | 4.86 |
| B (10% CPC) | 1.99 | 2.90 | 1.21 | 2.22 | 4.95 |
| C (20% CPC) | 2.02 | 2.86 | 1.14 | 2.22 | 4.68 |
| D (30% CPC) | 2.02 | 3.04 | 1.22 | 2.34 | 4.90 |
| | ADC (% dry matter) | | | | |
| Diet | TRP | PHE | LYS | HIS | ARG |
| A (reference) | 0.44 | 2.52 | 3.04 | 1.39 | 2.76 |
| B (10% CPC) | 0.51 | 2.59 | 3.18 | 1.46 | 2.99 |
| C (20% CPC) | 0.57 | 2.51 | 3.19 | 1.46 | 3.07 |
| D (30% CPC) | 0.66 | 2.65 | 3.35 | 1.59 | 3.38 |

The proximate composition (protein, lipid, dry matter, gross energy), titanium dioxide content, and individual amino acid content of the four fish food formulations, and in the feces collected daily from each tank, were analyzed at the Canadian Feed Research Centre of the University of Saskatchewan (Saskatoon, Saskatchewan) according to AOAC Official Methods (Horwitz, 2006): dry matter, 105° C. for 16 h (AOAC 930.15), nitrogen (AOAC 990.03; crude protein=Nx6.25), lipid (AOAC 920.39; ether extract). The concentrations of titanium oxide in the diets and feces was measured using the method taught by Short et al. (1996, Animal Feed Sci. Technol. 59:215-221). Titanium dioxide served as the digestibility indicator. The apparent digestibility coefficients (ADCs) of the nutrients were determined for each diet and for the test ingredients.

The digestibility of dry matter, protein, lipid, and gross energy of the control and the three CPC fish food formulations diets were determined, and the ADC of dry matter, protein, lipid, and gross energy of each of the formulations are shown in Table 35. Data are means (standard errors). There were no significant differences noted in the digestibility of dry matter, protein, lipid or gross energy between any of the four fish feed formulations during this study with Atlantic salmon.

TABLE 35
Assessment of the effects of canola protein concentrate
in fish feed formulations on Atlantic salmon nutrition

| | ADC (% dry matter) | | | |
|---|---|---|---|---|
| Feed | Dry | | | Gross |
| formulation | matter | Protein | Lipid | energy |
| A (Control) | 93.9 (0.3) | 87.5 (0.4) | 92.9 (0.9) | 84.3 (0.8) |
| B (10% CPC) | 94.6 (0.4) | 89.2 (0.5) | 92.1 (0.9) | 84.7 (1.0) |
| C (20% CPC) | 94.3 (0.2) | 87.8 (0.4) | 94.2 (0.5) | 84.8 (0.4) |
| D (30% CPC) | 95.0 (0.2) | 88.2 (0.2) | 94.3 (0.4) | 84.9 (0.3) |
| Significance¹ | P = 0.1093 | P = 0.0735 | P = 0.1551 | P = 0.9215 |

¹Significance of the one-way ANOVA between experimental diets.
(n = 3)

The apparent digestibility coefficient (ADC) of 10 essential amino acids in the three Atlantic salmon groups fed with fish feed formulations having increasing levels of canola protein concentrate, were also evaluated in comparison to the group that received the control fish feed formulation. The results are shown in Table 36 wherein the data are means (standard errors). Fish fed Diet B (CPC10) had markedly increased digestibility of valine (P=0.0297), isoleucine (P=0.0174), leucine (P=0.0146) and phenylalanine (P=0.0239) than fish fed either Diet C (CPC15) or Diet D (CPC20). The apparent digestibility of all other essential amino acids except for threonine were also numerically higher in fish feed diet B.

In addition, the apparent digestibility coefficients (ADC) of dry matter, protein, and gross energy in the canola protein concentrate provided in the three CPC-containing fish feed compositions fed to the Atlantic salmon, were also determined. The ADC digestibility of protein in the fish feed formulation comprising 10% CPC was 99.1%, the ADC digestibility of protein in the fish feed formulation comprising 20% CPC was 85.4%, ADC digestibility of protein in the fish feed formulation comprising 30% CPC was 88.8% (Table 37).

TABLE 36
Effects of increasing canola protein concentrates in fish feed formulations fed to Atlantic
salmon, on the apparent digestibility coefficient of 10 essential amino acids

| | ADC (% dry matter) | | | | |
|---|---|---|---|---|---|
| Diet | THR | VAL | MET | ILE | LEU |
| A Control | 86.9 (0.4) | 85.5 (0.4)^{ab} | 91.8 (0.4) | 88.6 (0.5)^{ab} | 88.6 (0.5)^{ab} |
| B (10% CPC) | 88.5 (0.9) | 87.1 (0.9)^{a} | 93.1 (0.6) | 89.6 (0.7)^{a} | 89.8 (0.8)^{a} |
| C (20% CPC) | 86.3 (0.4) | 84.4 (0.3)^{b} | 91.4 (0.3) | 87.1 (0.3)^{b} | 86.8 (0.4)^{b} |
| D (30% CPC) | 90.4 (3.1) | 84.6 (0.2)^{b} | 92.3 (0.3) | 87.1 (0.4)^{b} | 87.0 (0.4)^{b} |
| Significance¹ | P = 0.3480 | P = 0.0297 | P = 0.0875 | P = 0.0174 | P = 0.0146 |
| | ADC (% dry matter) | | | | |
| Diet | TRP | PHE | LYS | HIS | ARG |
| A (reference) | 88.3 (0.4)^{b} | 88.1 (0.4)^{ab} | 89.6 (0.3) | 85.2 (0.4) | 91.4 (0.2) |
| B (CPC10) | 90.3 (1.2)^{ab} | 89.4 (0.7)^{a} | 90.8 (0.8) | 87.8 (1.1) | 92.7 (0.5) |
| C (CPC20) | 90.0 (0.7)^{ab} | 86.7 (0.4)^{b} | 89.3 (0.4) | 86.1 (0.6) | 92.1 (0.3) |
| D (CPC30) | 92.4 (0.4)^{a} | 87.0 (0.4)^{b} | 89.8 (0.3) | 87.6 (0.4) | 92.1 (0.5) |
| Significance¹ | P = 0.0305 | P = 0.0239 | P = 0.2040 | P = 0.0806 | P = 0.1880 |

¹Significance of the one-way ANOVA between experimental diets.

TABLE 37
Effects of increasing canola protein concentrates in
fish feed formulations fed to Atlantic salmon, on the
apparent digestibility coefficient of CPC proteins.

| | ADC (% dry matter) | | |
|---|---|---|---|
| | Dry matter | Protein | Gross energy |
| 10% CPC | 106.4 (9.3) | 99.1 (4.7) | 80.7 (9.8) |
| 20% CPC | 101.6 (2.9) | 85.4 (1.7) | 86.6 (2.2) |
| 30% CPC | 105.3 (1.8) | 88.8 (0.6) | 86.5 (1.1) |
| Significance¹ | P = 0.7310 | P = 0.0482 | P = 0.6017 |

¹Significance of the one-way ANOVA between dietary inclusion on CPC.
10% CPC (n = 2), 20% and 30% CPC (n = 3)
(n = 3)

The ADCs for the essential amino acids in CPC were high and were not significantly affected by CPC inclusion rate (Table 38). These values are comparable to those obtained with Atlantic salmon fed menhaden fishmeal (5-01-985) and herring fishmeal (5-02-000) (NRC, 2011, Nutrient Requirements of Fish and Shrimp, Natl. Acad. Press, 376), suggesting CPC ingredient of the present disclosure is a nutrient-dense (protein) and highly digestible ingredient for Atlantic salmon.

TABLE 38
Apparent digestibility coefficients of essential amino acids in CPC

| Test | ADC (% dry matter) | | | | |
|---|---|---|---|---|---|
| Ingredient | THR | VAL | MET | ILE | LEU |
| B (CPC10) | 96.2 (9.9) | 94.8 (11.0) | 100.0 (5.8) | 93.2 (7.2) | 94.3 (9.1) |
| C (CPC20) | 84.4 (1.7) | 80.4 (1.6) | 90.2 (1.4) | 81.5 (1.4) | 79.6 (2.1) |
| D (CPC30) | 97.2 (9.0) | 82.8 (0.7) | 93.6 (0.9) | 84.0 (1.3) | 83.4 (1.2) |
| Significance¹ | P = 0.4221 | P = 0.1674 | P = 0.1153 | P = 0.1148 | P = 0.1189 |
| Test | ADC (% dry matter) | | | | |
| Ingredient | TRP | PHE | LYS | HIS | ARG |
| B (CPC10) | 98.8 (13.3) | 95.2 (8.8) | 96.3 (9.2) | 102.4 (12.1) | 100.8 (5.7) |
| C (CPC20) | 95.3 (2.8) | 81.4 (2.1) | 88.1 (1.9) | 89.5 (2.7) | 94.6 (1.5) |
| D (CPC30) | 98.6 (0.9) | 84.6 (1.3) | 90.1 (1.0) | 92.5 (1.3) | 93.5 (1.3) |
| Significance¹ | P = 0.8784 | P = 0.1300 | P = 0.4120 | P = 0.3100 | P = 0.2289 |

¹Significance of the one-way ANOVA between experimental diets.
(n = 3)

Also measured were the initial body weights (IBW), final body weights (FBW), feed intakes (FI), feed conversions (FCR), and growth rates of the four groups of Atlantic salmon, and were used to determine the effects of increasing the CPC protein contents in the fish feed formulations on the thermal growth unit coefficients (TGC) of the three groups of test Atlantic salmon (Table 39). Data are means (standard errors). Means within a column with no superscript in common differ significantly (P<0.05) based on the Tukey test (the absence of superscript indicates no difference).

TABLE 39
Effects of increasing CPC protein contents on the thermal
growth unit coefficients of Atlantic salmon.

| | IBW | FBW | FI | FCR | |
|---|---|---|---|---|---|
| Diet | (g/fish) | (g/fish) | (g/fish) | (feed:gain) | TGC |
| A (Control) | 59.1 (0.0) | 86.2 (7.6) | 28.2 (6.0) | 1.06 (0.08) | 0.120 (0.030) |
| B (10% CPC) | 60.7 (7.2) | 89.8 (15.4) | 29.3 (5.9) | 1.07 (0.11) | 0.148 (0.046) |
| C (20% CPC) | 57.8 (3.5) | 87.2 (9.7) | 30.7 (6.0) | 1.05 (0.02) | 0.129 (0.020) |
| D (30% CPC) | 53.5 (1.4) | 72.5 (3.8) | 21.6 (1.8) | 1.16 (0.07) | 0.092 (0.010) |
| Significance¹ | P = 0.7043 | P = 0.6492 | P = 0.5958 | P = 0.7621 | P = 0.6136 |

¹Significance of the one-wav ANOVA between experimental diets.
(n = 3) for experimental Diets B.C. and D, (n = 2) for experimental Diet A

There were no significant differences observed in final body weights, feed intakes, feed conversions, or growth rates of juvenile Atlantic salmon fed the experimental fish feed formulations for 34 days. These data indicate that the protein concentrates disclosed herein are of very high quality and the levels of known canola anti-nutrients such as phytic acid, tannins, glucosinolates did not reach levels that might depress salmon growth and feed intake (Burr et al. (2013) International Aquatic Research 5:5).

1. A plant protein concentrate comprising at least about 65% (w/w) plant protein, from about 4% (w/w) to about 10% (w/w) plant oil, and from about 0.5% (w/w) to about 15% (w/w) carbohydrates.

2. The plant protein concentrate according to claim 1, further comprising about 4% (w/w) to about 10% (w/w) moisture and from about 0.1% (w/w) to about 12% (w/w) ash).

3. The plant protein concentrate according to claim 1, wherein the protein concentrate comprises at least about 70% (w/w) plant protein.

4. The plant protein concentrate according to claim 1, wherein the protein concentrate comprises at least about 75% (w/w) plant protein.

5. The plant protein concentrate according to claim 1, wherein the weight percentage of essential amino acids in the plant protein is at least about 30% by weight protein.

6. The plant protein concentrate according to claim 1, wherein the weight percentage of essential amino acids in the plant protein is at least about 35% by weight protein.

7. The plant protein concentrate according to claim 1, wherein the weight percentage of essential amino acids in the plant protein is at least about 40% by weight protein.

8. The plant protein concentrate according to claim 1, wherein the weight percentage of lysine in the plant protein is at least about 3.0% by weight crude protein.

9. The plant protein concentrate according to claim 1, wherein the weight percentage of lysine in the plant protein is at least about 5.0% by weight crude protein.

10. The plant protein concentrate according to claim 1, wherein the weight percentage of lysine in the plant protein is at least about 7.0% by weight crude protein.

11. The plant protein concentrate according to claim 1, wherein the plant proteins within the plant protein concentrate are substantially non-denatured.

12. The plant protein concentrate according to claim 1, wherein the protein concentrate is substantially free of at least one of the anti-nutritional constituents selected from the group consisting of glucosinolates, polyphenols, tannins, sinapine, phytate, and stachyose.

13. The plant protein concentrate according to claim 1, wherein the protein concentrate is substantially free of insoluble non-starch polysaccharides.

14. The plant protein concentrate according to claim 1, wherein the protein is at least about 75% digestible.

15. The plant protein concentrate according to claim 1, wherein the protein is at least about 95% digestible.

16. The plant protein concentrate according to claim 1, wherein the protein is at least about 99% digestible.

17. The plant protein concentrate according to claim 1, wherein the protein concentrate is recovered from whole plant seeds.

18. The plant protein concentrate according to claim 1, wherein the protein concentrate is recovered from a press cake.

19. The plant protein concentrate according to claim 1, wherein the protein concentrate is recovered from a Brassica plant.

20. A method of making a plant protein concentrate, the method comprising:
(i) providing whole plant seeds;
(ii) comminuting the whole plant seeds in an aqueous solution to obtain a mixture comprising comminuted plant seed particles having mean particle sizes in a range of about 5 μm to about 200 μm;
(iii) separating the mixture into a solid phase and a liquid phase;
(iv) separating the liquid phase in a light liquid phase and a heavy liquid phase;
(v) separating the heavy liquid phase to recover therefrom a protein-containing heavy liquid phase and an oil-containing light liquid phase; and
(vi) precipitating proteins from the protein-containing heavy liquid phase thereby producing a solid protein precipitate and a liquid protein solution.

21. The method according to claim 20, wherein the heavy liquid phase in step (v) is gravitationally separated.

22. The method according to claim 20, additionally comprising a step (vii) of concentrating the solid first protein precipitate from step (vi) to produce a first protein concentrate.

23. The method according to claim 22, wherein the first protein concentrate comprises at least about 65% (w/w) plant protein, from about 4% (w/w) to about 10% (w/w) plant oil, and from about 0.5% (w/w) to about 15% (w/w) carbohydrates.

24. The method according to claim 20, additionally comprising a step (viii) of treating the liquid protein solution by ultrafiltration to obtain a first retentate and a step (ix) of concentrating the retentate to produce a second protein concentrate.

25. The method according to claim 20, additionally comprising a step (x) of blending the first protein concentrate of step (vi) with the second protein concentrate of step (ix) to produce a third protein concentrate.

26. The method according to claim 20, wherein the second protein concentrate comprises at least about 65% (w/w) plant protein, from about 4% (w/w) to about 10% (w/w) plant oil, and from about 0.5% (w/w) to about 15% (w/w) carbohydrates.

27. The method according to claim 20, wherein comminuting the whole plant seeds in an aqueous solution comprises wet-milling the whole plant seeds in an aqueous solution thereby producing the comminuted plant seed particles.

28. A method of making a plant protein concentrate, the method comprising:
(i) providing one of a press cake in the form of one of a press cake, a seed cake, a seed meal, or a non-toasted solvent-extracted press-cake;
(ii) soaking the press cake in a selected aqueous solution thereby providing a more or less homogenous mixture of soaked press cake;
(iii) separating the soaked press cake mixture into a first liquid phase and a first solid phase;
(iv) separating the first liquid phase into a first protein precipitate and a second liquid phase, wherefrom the first protein precipitate is concentrated into a first protein concentrate;
(v) separating a first retentate from the second liquid phase and then concentrating the first retentate to produce a second protein concentrate;
(vi) diluting the first solid phase and then separating the diluted first solid phase into a second solid phase and a third liquid phase;
(vii) separating the third liquid phase into a second protein precipitate and a fourth liquid phase, wherefrom the second protein precipitate may be concentrated to produce a third protein concentrate; and
(viii) recovering a second retentate from the fourth liquid phase and concentrating said retentate to produce a fourth protein concentrate.

29. The method according to claim 28, additionally comprising a step (ix) of blending the first protein precipitate from step (iv) with the second protein precipitate from step (vii) to produce a third protein precipitate and concentrating the third protein precipitate to produce a fifth protein concentrate.

30. The method according to claim 28, additionally comprising a step (x) of blending the first protein precipitate from step (iv) with the second protein precipitate from step (vii) to produce a blended third protein precipitate and adding the first retentate from step (v) and blending and concentrating the blend to produce a sixth protein concentrate.

31. The method according to claim 28, additionally comprising a step (xi) of blending the first protein precipitate from step (iv) with the second protein precipitate from step (vii) to produce third protein precipitate and adding the second retentate from step (viii) and blending and concentrating the blend to produce a seventh protein concentrate

32. The method according to claim 28, additionally comprising a step (xii) of blending the first protein precipitate from step (iv) with the second protein precipitate from step (vii) to produce a third protein precipitate and concentrating the blended third protein precipitate to produce a fifth protein concentrate and adding the second protein concentrate from step (v) and the fourth protein concentrate from step (viii) and blend and concentrating the blend to produce an eighth protein concentrate.

33. The method according to claim 28, wherein a protein concentrate produced therewith comprises at least about 65% (w/w) plant protein, from about 4% (w/w) to about 10% (w/w) plant oil, and from about 0.5% (w/w) to about 15% (w/w) carbohydrates.

34. A nutritional formulation comprising (i) a plant protein concentrate according to claim 20, and (ii) a formulary ingredient, wherein said plant protein concentrate and said formulary ingredient are blended together.

35. The nutritional formulation according to claim 34, wherein the formulation is an animal feed.

36. The nutritional formulation according to claim 34, wherein the formulation is a human food.

37. The nutritional formulation according to claim 34, wherein the formulation is an aquaculture feed.

38. The nutritional formulation according to claim 34, wherein the formulation is the nutritional formulation is an aquaculture feed wherein the aquaculture feed is substantially free of insoluble non-starch polysaccharides.

39. The nutritional formulation according to claim 37, wherein the aquaculture feed is a fish feed.

40. The nutritional formulation according to claim 39, wherein the fish feed is salmon fish feed.

41. The nutritional formulation according to claim 40, wherein the salmon fish feed comprises digestible arginine from at least about 93% to about 100%; digestible histidine from at least about 92% to about 100%; digestible isoleucine from at least about 84% to at least about 93%; digestible leucine from at least about 83% to at least about 94%; digestible lysine from at least about 90% to at least about 96%; digestible methionine from at least about 94% to about 100%; digestible phenylalanine from at least about 85% to at least about 95%; digestible threonine from at least about 84% to at least about 97%; digestible tryptophan from at least about 95% to about 100%; and/or digestible valine from at least about 80% to at least about 95%.

42. A method of preparing a nutritional formulation, the method comprising:
(i) providing a plant protein concentrate according to claim 20;
(ii) providing a formulary ingredient suitable for inclusion in a nutritional formulation; and
(i) blending together the plant protein concentrate with the formulary ingredient to form the nutritional formulation comprising the plant protein concentrate.

43. A use of a plant protein concentrate according to claim 20 to formulate a nutritional formulation therewith.
